(19) United States
(12) Patent Application Publication
(10) Pub. No.: US 2017/0013637 A1
(43) Pub. Date: Jan. 12, 2017

(54) RECEIVING DEVICE AND METHOD

(71) Applicant: FUJITSU LIMITED, Kawasaki-shi (JP)

(72) Inventors: Kaoru YOKOO, Yokosuka (JP); Kazuyuki OZAKI, Yokohama (JP); Hiroo URABE, Kawasaki (JP); Hlroshi FUJITA, Yokosuka (JP)

(73) Assignee: FUJITSU LIMITED, Kawasaki-shi (JP)

(21) Appl. No.: 15/200,904

(22) Filed: Jul. 1, 2016

(30) Foreign Application Priority Data
Jul. 8, 2015 (JP) 2015-136606

(51) Int. Cl. H04W 72/12; H04W 72/04; H04L 12/26

(52) U.S. Cl. CPC H04W 72/1231; H04L 43/0823; H04W 72/0446

(57) ABSTRACT

A receiving device includes a receiving circuit configured to receive a first packet and a second packet, each of the first packet and the second packet including a first signal in a head and a second signal in a tail, respectively, and a processor configured to detect a collision of the first packet and the second packet based on a receiving timing of the first signal of the first packet, a receiving timing of the second signal of the first packet, and at least one of a receiving timing of the first signal of the second packet and a receiving timing of the second signal of the second packet, after detecting the collision, separate the first packet and the second packet based on the first signal of the first packet and the second signal of the second packet, and demodulate the separated first packet and the separated second packet, respectively.

### CROSS-REFERENCE TO RELATED APPLICATION

This application is based upon and claims the benefit of priority of the prior Japanese Patent Application No. 2015-136606, filed on Jul. 8, 2015, the entire contents of which are incorporated herein by reference.

### FIELD

The embodiments discussed herein are related to a receiving device and a method.

### BACKGROUND

Traditionally, a technique for inserting a knowing signal (preamble) in a head portion of a packet has been known. In addition, a technique for inserting a knowing signal (preamble) in a head portion of a packet and inserting a known signal (postamble) in a tail portion of the packet has been known.

As an example of related art, Japanese Laid-open Patent Publication No. 10-107863, Japanese Laid-open Patent Publication No. 5-122165, and Japanese Laid-open Patent Publication No. 2009-201083 are known.

### SUMMARY

According to an aspect of the invention, a receiving device includes a receiving circuit configured to receive a first packet and a second packet, each of the first packet and the second packet including a first signal in a head and a second signal in a tail, respectively, and a processor coupled to the receiving circuit and configured to detect a collision of the first packet and the second packet based on a receiving timing of the first signal of the first packet, a receiving timing of the second signal of the first packet, and at least one of a receiving timing of the first signal of the second packet and a receiving timing of the second signal of the second packet, after detecting the collision, separate the first packet and the second packet based on the first signal of the first packet and the second signal of the second packet, and demodulate the separated first packet and the separated second packet, respectively.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of a communication system according to a first embodiment.

FIG. 2 illustrates an example of transmitting devices according to the first embodiment.

FIG. 3 illustrates an example of a hardware configuration of a sensor node according to the first embodiment.

FIG. 4 illustrates an example of a packet generated by a packet generator according to the first embodiment.

FIG. 5 illustrates an example of a receiving device according to the first embodiment.

FIG. 6 illustrates an example of collision detecting and channel estimating sections according to the first embodiment.

FIG. 7 illustrates an example of a hardware configuration of a base station according to the first embodiment.

FIG. 8 is a flowchart of an example of a process to be executed by the receiving device according to the first embodiment.

FIG. 9 illustrates an example of the collision of packets in a case where the lengths of packets are fixed in the first embodiment.

FIG. 10 is a flowchart of a detection process to be executed by a collision detector according to the first embodiment in the case where the lengths of the packets are fixed.

FIG. 11 is a flowchart of another example of the detection process to be executed by the collision detector according to the first embodiment in the case where the lengths of the packets are fixed.

FIG. 12 illustrates an example of the collision of the packets in a case where the lengths of the packets are variable in the first embodiment.

FIG. 13 is a flowchart of an example of the detection process to be executed by the collision detector according to the first embodiment in the case where the lengths of the packets are variable.

FIG. 14 is a flowchart of another example of the detection process to be executed by the collision detector according to the first embodiment in the case where the lengths of the packets are variable.

FIG. 15 illustrates another example of the collision of the packets in the case where the lengths of packets are variable in the first embodiment.

FIG. 16 illustrates an example of the transmitting devices according to a second embodiment.

FIG. 17 illustrates an example of a packet generated by the packet generator according to the second embodiment.

FIG. 18 illustrates an example of the collision detecting and channel estimating sections according to the second embodiment.

FIG. 19 illustrates an example of the collision of the packets in a case where the lengths of the packets are fixed in the second embodiment.

FIG. 20 is a flowchart of an example of the detection process to be executed by the collision detector according to the second embodiment in the case where the lengths of the packets are fixed.

FIG. 21 illustrates an example of the collision of the packets in a case where the lengths of the packets are variable in the second embodiment.

FIG. 22 is a flowchart of another example of the detection process to be executed by the collision detector according to the second embodiment in the case where the lengths of the packets are variable.

FIG. 23 is a flowchart of another example of the detection process to be executed by the collision detector according to the second embodiment in the case where the lengths of the packets are variable.

FIG. 24 illustrates another example of the collision of the packets in the case where the lengths of the packets are variable in the second embodiment.

FIG. 25 illustrates an example of a network to which the communication system according to the embodiments is applicable.

FIG. 26 illustrates another example of the network to which the communication system according to the embodiments is applicable.

### DESCRIPTION OF EMBODIMENT(S)

The aforementioned conventional techniques, however, have a problem that if packets transmitted by multiple transmitting devices collide with each other, channel estimation values of the colliding packets are not obtained and it is difficult to receive the colliding packets.

Hereinafter, embodiments of a receiving device, transmitting device, and communication method according to the disclosure are described in detail with reference to the accompanying drawings.

### First Embodiment

### Communication System According to First Embodiment

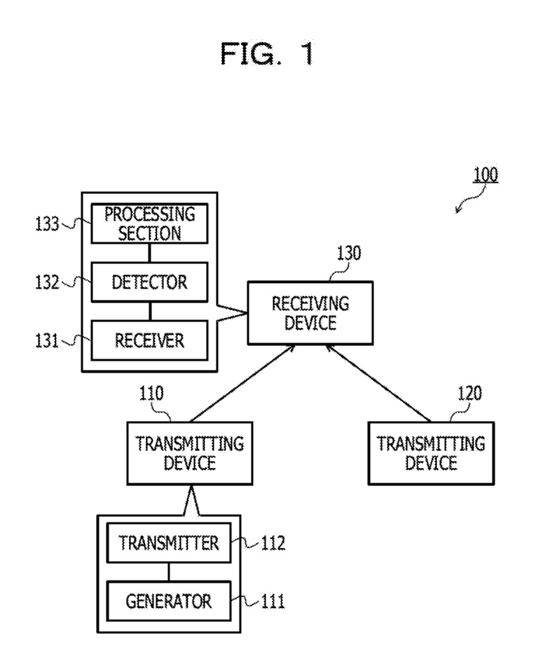

FIG. 1 illustrates an example of a communication system according to a first embodiment. As illustrated in FIG. 1, the communication system 100 according to the first embodiment includes transmitting devices 110 and 120 and a receiving device 130. The transmitting devices 110 and 120 transmit packets to the receiving device 130. The receiving device 130 receives the packets transmitted by the transmitting devices 110 and 120.

In the communication system 100, the packets transmitted by the transmitting devices 110 and 120 to the receiving device 130 may chronologically overlap each other and thereby collide with each other in the receiving device 130. For example, in the communication system 100, the transmitting devices 110 and 120 transmit the packets without scheduling that is executed to assign time resources to the transmitting devices 110 and 120 in order to avoid the collision of the packets. In this configuration, the packets transmitted by the transmitting devices 110 and 120 may collide with each other.

The configuration of the transmitting device 110 is described below and is the same as or similar to the configuration of the transmitting device 120. The transmitting device 110 includes a generator 111 and a transmitter 112. The generator 111 generates a packet including a predetermined first signal (hereinafter referred to as “preamble”) in a head and including a predetermined second signal (hereinafter referred to as “postamble”) in a tail. The head of the packet is a portion to be chronologically received first among the packet. The tail of the packet is a portion to be chronologically received last among the packet.

The generator 111 outputs the generated packet to the transmitter 112. The transmitter 112 transmits the packet output from the generator 111 to the receiving device 130. For example, the transmitter 112 wirelessly transmits the packet output from the generator 111.

The preamble and the postamble that are stored in the packet by the generator 111 are known signals composed of patterns (codes) known to the receiving device 130, for example. In addition, the preamble and the postamble that are stored in the packet by the generator 111 may be known signals that are the same as or different from each other.

In addition, the preamble generated by the generator 111 of the transmitting device 110 and a preamble generated by the generator 111 of the transmitting device 120 may be known signals that are the same as or different from each other. The postamble generated by the generator 111 of the transmitting device 110 and a postamble generated by the generator 111 of the transmitting device 120 may be known signals that are the same as or different from each other.

The receiving device 130 includes a receiver 131, a detector 132, and a processing section 133. The receiver 131 receives signals including the packets transmitted by the transmitting devices 110 and 120. Then, the receiver 131 outputs the received signals to the detector 132. For example, the receiving device 130 simultaneously uses multiple antennas to receive the signals.

The detector 132 detects the collision of the packets included in the signals output from the receiver 131. For example, the detector 132 detects the collision of the packets based on timings of the preambles and postambles included in the signals output from the receiver 131 and the lengths (packet lengths) of the packets transmitted by the transmitting device 110 and 120. Then, the detector 132 outputs, to the processing section 133, the result of detecting the collision and the signals output from the receiver 131.

As the packet lengths used for the detector 132 to detect the collision of the packets, the length of a preceding packet among the colliding packets is used, for example. The lengths of the packets are fixed in the communication system 100 and known to the receiving device 130, for example. Alternatively, the lengths of the packets may be variable (or may not be fixed) in the communication system 100. In this case, the receiving device 130 acquires information indicating the lengths of the packets from the headers of the received packets, for example.

If the collision of the packets is detected, the processing section 133 executes channel estimation based on the result, output from the detector 132, of detecting the collision and based on the preamble included in the head of the preceding packet among the packets of which the collision was detected. The channel estimation is to estimate an impulse response of a transmission path, for example. For example, the processing section 133 executes the channel estimation on each of the signals received by the multiple antennas of the receiver 131 based on the preamble included in the preceding packet among the packets of which the collision was detected.

In this case, the processing section 133 executes the channel estimation based on a postamble included in a succeeding packet among the packets of which the collision was detected. For example, the processing section 133 executes the channel estimation on each of the signals received by the multiple antennas of the receiver 131 based on the postamble included in the succeeding packet among the packets of which the collision was detected.

Then, the processing section 133 executes signal separation on colliding portions of the packets of which the collision was detected, based on channel estimation values (channel estimation results) obtained by the channel estimation. Thus, even if the packets collide with each other, the signal separation is executed on the colliding packets, and the colliding packets are received (demodulated).

Although the present embodiment describes the case where the transmitting devices 110 and 120 transmits the packets to the receiving device 130, each of the transmitting devices 110 and 120 may have a function of receiving packets from other communication devices. In addition, the receiving device 130 may have a function of transmitting a packet to another communication device.

(Transmitting Devices According to First Embodiment)

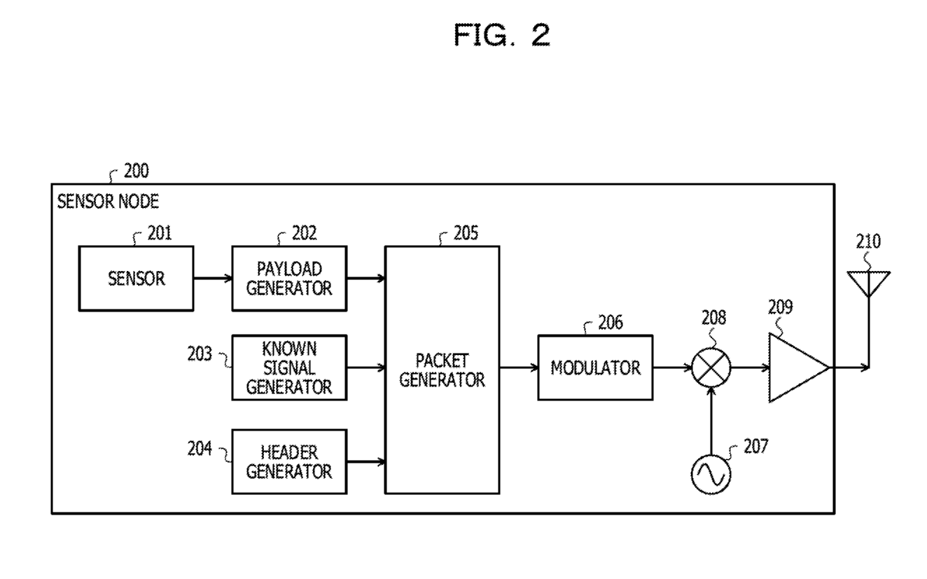

FIG. 2 illustrates an example of the transmitting devices according to the first embodiment. Each of the transmitting devices 110 and 120 illustrated in FIG. 1 is achieved by a sensor node 200 illustrated in FIG. 2, for example. The sensor node 200 includes a sensor 201, a payload generator 202, a known signal generator 203, a header generator 204, a packet generator 205, a modulator 206, an oscillator 207, a multiplier 208, an amplifier 209, and an antenna 210.

The sensor 201 detects specific physical amounts of the surrounding of the sensor 201 and outputs, to the payload generator 202, sensing data indicating the results of the detection. The physical amounts detected by the sensor 201 may be various physical amounts such as a temperature, pressure, a flow rate, light, and magnetism, for example. The payload generator 202 generates a payload including the sensing data output from the sensor 201 and outputs the generated payload to the packet generator 205.

The known signal generator 203 generates known signals and outputs the generated known signals to the packet generator 205. The known signals each have a predetermined pattern (code) that is known to the transmitting devices 110 and 120 that are on a transmission side and is known to the receiving device 130 that is on a reception side. In the first embodiment, the known signal generator 203 generates the known signals that are used in common for both preamble and postamble of a packet to be transmitted by the sensor node 200. The known signals may have low mutual correlations with other signals such as the payload and a header, for example.

The header generator 204 generates the header of the packet to be transmitted by the sensor node 200 and outputs the generated header to the packet generator 205. The header generated by the header generator 204 includes information indicating the length of the packet to be transmitted by the sensor node 200 and the like, for example. In addition, the header generated by the header generator 204 may include an identifier of the transmission source (sensor node 200), an identifier of the transmission destination (receiving device 130), and the like.

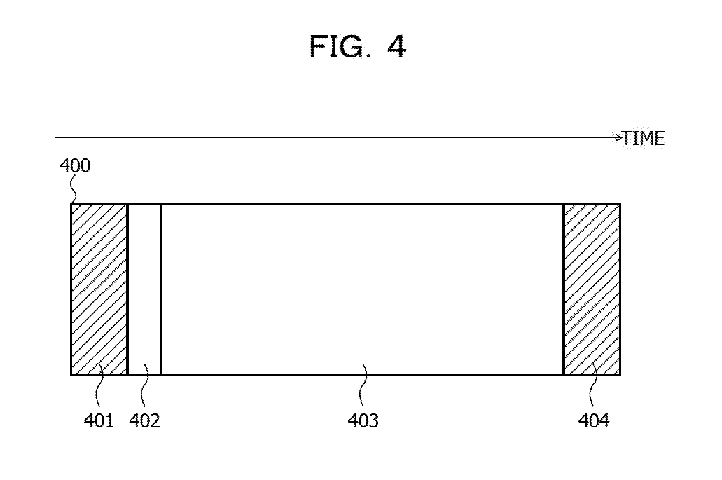

The packet generator 205 generates a packet based on the payload output from the payload generator 202, the known signals output from the known signal generator 203, and the header output from the header generator 204. The packet generated by the packet generator 205 is described later (refer to, for example, FIG. 4). The packet generator 205 outputs the generated packet to the modulator 206.

The modulator 206 executes modulation based on the packet output from the packet generator 205. Various modulation schemes such as intensity modulation and phase modulation may be used in the modulation by the modulator 206. The modulator 206 outputs a signal obtained by the modulation to the multiplier 208.

The oscillator 207 causes a clock signal to oscillate at a predetermined frequency and outputs the oscillating clock signal to the multiplier 208. The multiplier 208 multiplexes the signal output from the modulator 206 by the clock signal output from the oscillator 207. By the multiplication, frequency conversion (up-conversion) is executed on the signal output from the modulator 206 to the multiplier 208 so as to convert the signal from a baseband to a radio frequency (RF) band. The multiplier 208 outputs the signal subjected to the frequency conversion to the amplifier 209.

The amplifier 209 amplifies the signal output from the multiplier 208 and outputs the amplified signal to the antenna 210. The antenna 210 wirelessly transmits the signal output from the amplifier 209. By the wireless transmission of the signal, the packet generated by the packet generator 205 is wirelessly transmitted.

For example, the sensor node 200 regularly (for example, periodically) executes sensing by the sensor 201 and wirelessly transmits a packet including sensing data to the receiving device 130 for each execution of the sensing. Thus, the packet may collide with a packet transmitted by another communication device, depending on the timing of the transmission of the packet by the sensing node 200.

Each of the generators 111 of the transmitting devices 110 and 120 illustrated in FIG. 1 may be achieved by the payload generator 202, the known signal generator 203, the header generator 204, and the packet generator 205, for example. Each of the transmitters 112 of the transmitting devices 110 and 120 illustrated in FIG. 1 may be achieved by the modulator 206, the oscillator 207, the multiplier 208, the amplifier 209, and the antenna 210, for example.

(Hardware Configuration of Sensor Node According to First Embodiment)

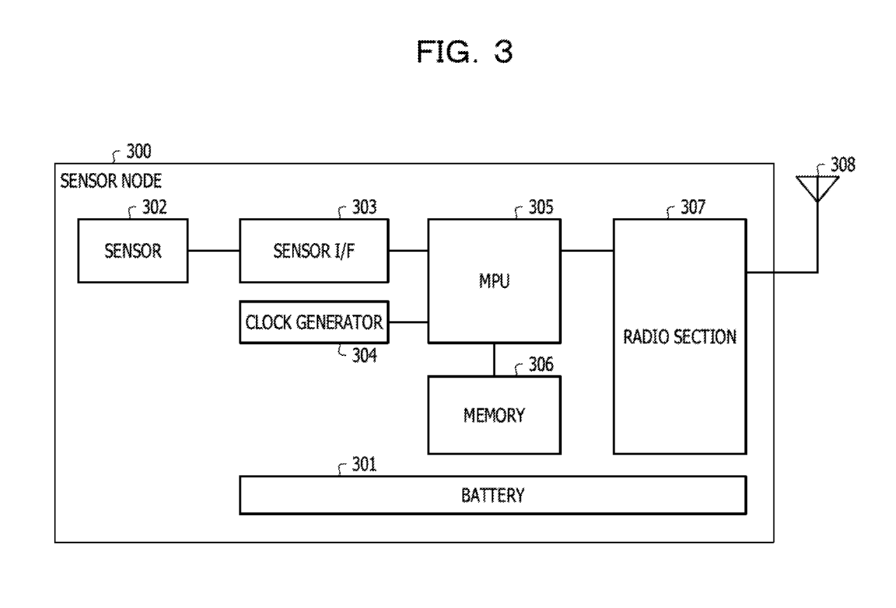

FIG. 3 illustrates an example of a hardware configuration of the sensor node according to the first embodiment. The sensor node 200 illustrated in FIG. 2 may be achieved by a sensor node 300 illustrated in FIG. 3, for example. The sensor node 300 includes a battery 301, a sensor 302, a sensor I/F 303, a clock generator 304, an MPU 305, a memory 306, a radio section 307, and an antenna 308.

The battery 301 supplies a voltage to each of the parts of the sensor node 300. The sensor 302 has a configuration corresponding to the sensor 201 illustrated in FIG. 2. The sensor I/F 303 is a communication interface configured to enable communication to be executed between the sensor 302 and the MPU 305. The clock generator 304 generates an operation clock for the MPU 305.

The micro processing unit (MPU) 305 controls the overall sensor node 300. The payload generator 202, the known signal generator 203, the header generator 204, and the packet generator 205 that are illustrated in FIG. 2 may be achieved by the MPU 305, for example.

The memory 306 includes a main memory and an auxiliary memory, for example. The main memory is a random access memory (RAM), for example. The main memory is used as a work area of the MPU 305. The auxiliary memory is a nonvolatile memory such as a magnetic disk or a flash memory, for example. The auxiliary memory stores various programs to be executed to cause the sensor node 300 to operate. The programs stored in the auxiliary memory are loaded into the main memory and executed by the MPU 305.

The radio section 307 is a circuit configured to execute radio communication using the antenna 308 in accordance with control by the MPU 305. The modulator 206, the oscillator 207, the multiplier 208, and the amplifier 209 that are illustrated in FIG. 2 are included in the radio section 307, for example. The antenna 308 has a configuration corresponding to the antenna 210 illustrated in FIG. 2.

(Packet Generated by Packet Generator According to First Embodiment)

FIG. 4 illustrates an example of the packet generated by the packet generator according to the first embodiment. In FIG. 4, the abscissa indicates time. The packet generator 205 of the sensor node 200 illustrated in FIG. 2 generates a packet 400 illustrated in FIG. 4, for example. The packet 400 includes a preamble 401, a header 402, a payload 403, and a postamble 404.

The preamble 401 is a known signal output from the known signal generator 203 illustrated in FIG. 2 to the packet generator 205. In addition, the preamble 401 is stored in the head of the packet 400. The header 402 is the header output from the header generator 204 illustrated in FIG. 2 to the packet generator 205. In addition, the header 402 is stored immediately after the preamble 401 in the packet 400.

The payload 403 is the payload output from the payload generator 202 illustrated in FIG. 2 to the packet generator 205. In addition, the payload 403 is stored immediately after the header 402 in the packet 400.

The postamble 404 is a known signal output from the known signal generator 203 illustrated in FIG. 2 to the packet generator 205 in the same manner as the preamble 401. In addition, the postamble 404 is stored immediately after the payload 403 in the tail of the packet 400. In the first embodiment, the known signals that have the same pattern are used as the preamble 401 and the postamble 404.

(Receiving Device According to First Embodiment)

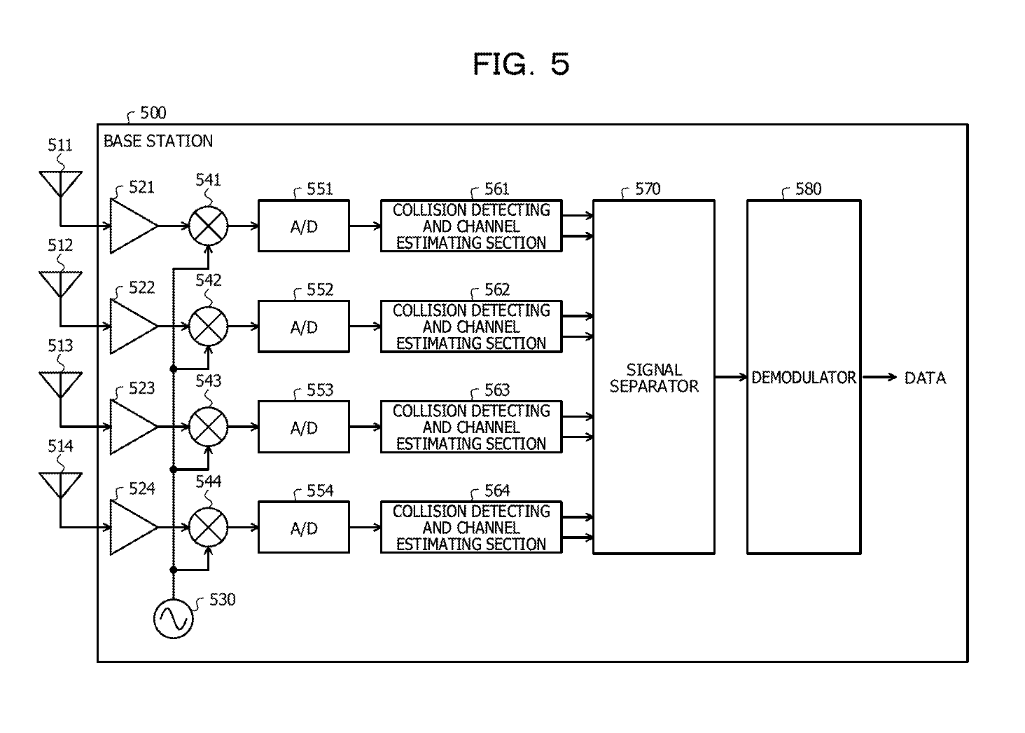

FIG. 5 illustrates an example of the receiving device according to the first embodiment. The receiving device 130 illustrated in FIG. 1 may be achieved by a base station 500 illustrated in FIG. 5, for example. The base station 500 includes antennas 511 to 514, amplifiers 521 to 524, an oscillator 530, multipliers 541 to 544, digital converters 551 to 554, collision detecting and channel estimating sections 561 to 564, a signal separator 570, and a demodulator 580.

The antennas 511 to 514 are arranged at intervals in an array. The antennas 511 to 514 receive signals wirelessly transmitted by other communication devices (for example, the transmitting devices 110 and 120). Then, the antennas 511 to 514 output the received signals to the amplifiers 521 to 524.

The amplifiers 521 to 524 amplify the signals output from the antennas 511 to 514. Then, the amplifiers 521 to 524 output the amplified signals to the multipliers 541 to 544. The oscillator 530 causes a clock signal to oscillate at a predetermined frequency and outputs the oscillating clock signal to the multipliers 541 to 544.

The multiplier 541 multiplies signals output from the amplifier 521 by the clock signal output from the oscillator 530. By the multiplication, frequency conversion (down-conversion) is executed on the signals output from the amplifier 521 to the multiplier 541 so as to convert the signal from the RF band to the base band. The multiplier 541 outputs the signals subjected to the frequency conversion to the digital converter 551.

Similarly, the multipliers 542 to 544 multiply signals output from the amplifiers 522 to 524 by the clock signal output from the oscillator 530. By the multiplication, the frequency conversion (down-conversion) is executed on the signals output from the amplifiers 522 to 524 to the multipliers 542 to 544 so as to convert the signals from the RF band to the base band. The multipliers 542 to 544 output the signals subjected to the frequency conversion to the digital converters 552 to 554.

The digital converters 551 to 554 (A/D) convert the signals output from the multipliers 541 to 544 from the analog signals to digital signals. Then, the digital converters 551 to 554 output, as received signals, the signals subjected to the digital conversion to the collision detecting and channel estimating sections 561 to 564.

The collision detecting and channel estimating sections 561 to 564 detect the collision of packets based on the received signals output from the digital converters 551 to 554. In addition, the collision detecting and channel estimating sections 561 to 564 use the results of detecting the collision of the packets to execute the channel estimation based on the received signals output from the digital converters 551 to 554.

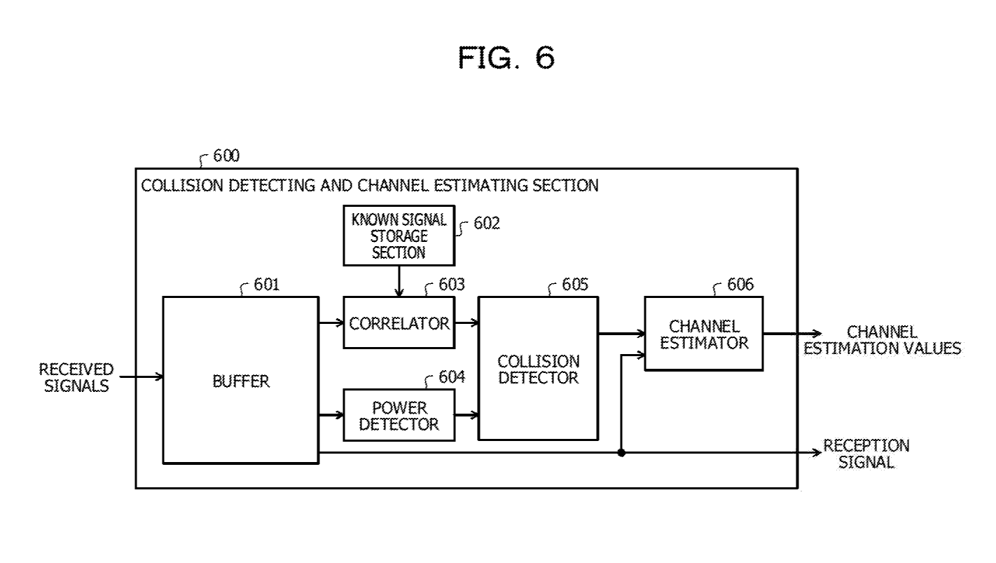

Then, the collision detecting and channel estimating sections 561 to 564 output channel estimation values obtained by the channel estimation to the signal separator 570. In addition, the collision detecting and channel estimating sections 561 to 564 output the received signals output from the digital converters 551 to 554 to the signal separator 570. Processes to be executed by the collision detecting and channel estimating sections 561 to 564 are described later (refer to, for example, FIG. 6).

The signal separator 570 executes the signal separation (collision separation) on the received signals output from the collision detecting and channel estimating sections 561 to 564 based on the channel estimation values output from the collision detecting and channel estimating sections 561 to 564. Thus, if the packets transmitted by the multiple transmitting devices (for example, the transmitting devices 110 and 120) collide with each other, the packets are separated.

In the signal separation by the signal separator 570, various processes such as maximum likelihood detection (MLD), a minimum mean square error (MMSE), and the like may be used, for example. The signal separator 570 outputs the signals obtained by the signal separation to the demodulator 580.

As an example, a case where the signal separation is executed by the signal separator 570 using MLD is described below. The signals r received by the receiving device 130 are expressed by the following Equation (1), for example:

r=h1*s1+h2*s2+n (1)

Where r is a vector indicating the signals received by the antennas 511 to 514, h1 is a vector indicating characteristics of a transmission path between the transmitting device 110 and the antennas 511 to 514, h2 is a vector indicating characteristics of a transmission path between the transmitting device 120 and the antennas 511 to 514, s1 is the signal transmitted by the transmitting device 110 to the receiving device 130, s2 is the signal transmitted by the transmitting device 120 to the receiving device 130, and n indicates noise.

The signal separator 570 sets the received signals output from the collision detecting and channel estimating sections 561 to 564 to the vector r. In addition, the signal separator 570 sets the channel estimation values output from the collision detecting and channel estimating sections 561 to 564 for the transmitting device 110 to the vector h1. In addition, the signal separator 570 sets the channel estimation values output from the collision detecting and channel estimating sections 561 to 564 for the transmitting device 120 to the vector h2. Then, the signal separator 570 identifies, from candidates for a combination of the values s1 and s2, a candidate having the highest likelihood based on the aforementioned Equation (1) and obtains the identified combination as the results of the separation.

The demodulator 580 executes demodulation based on the signals output from the signal separator 570. By the demodulation, data included in the packets transmitted by the transmitting devices 110 and 120 is reproduced. The data reproduced by the demodulator 580 includes the payload (for example, sensing data) generated by the payload generator 202 illustrated in FIG. 2, for example.

Although the case where the base station 500 has the four antennas (antennas 511 to 514) is described, the number of antennas included in the base station 500 is not limited to four and may be changed to 2, 3, or 5 or more. In such a case, amplifiers, multipliers, digital converters, and collision detecting and channel estimating sections are arranged for the number of the antennas.

The receiver 131 of the receiving device 130 illustrated in FIG. 1 is achieved by the antennas 511 to 514, the amplifiers 521 to 524, the oscillator 530, the multipliers 541 to 544, and the digital converters 551 to 554, for example. The detector 132 of the receiving device 130 illustrated in FIG. 1 is achieved by the collision detecting and channel estimating sections 561 to 564, for example. The processing section 133 of the receiving device 130 illustrated in FIG. 1 is achieved by the signal separator 570, for example.

(Collision Detecting and Channel Estimating Sections According to First Embodiment)

FIG. 6 illustrates an example of the collision detecting and channel estimating sections according to the first embodiment. Each of the collision detecting and channel estimating sections 561 to 564 illustrated in FIG. 5 is achieved by a collision detecting and channel estimating section 600 illustrated in FIG. 6, for example. The collision detecting and channel estimating section 600 includes a buffer 601, a known signal storage section 602, a correlator 603, a power detector 604, a collision detector 605, and a channel estimator 606.

Although a case where the collision detecting and channel estimating section 600 is applied to the collision detecting and channel estimating section 561 among the collision detecting and channel estimating sections 561 to 564 is described below, the same applies to cases where the collision detecting and channel estimating section 600 is applied to the collision detecting and channel estimating sections 562 to 564. In the case where the collision detecting and channel estimating section 600 is applied to the collision detecting and channel estimating section 561, the signals received by the antenna 511 illustrated in FIG. 5 and processed by the amplifier 521, the multiplier 541, and the digital converter 551 are input to the buffer 601.

The buffer 601 stores (buffers) the signals received within the latest time period of a predetermined length among input received signals. The predetermined length may be approximately twice as long as the longest packet length among the packets transmitted by the transmitting devices 110 and 120 or may be twice or more as long as the longest packet length among the packets transmitted by the transmitting devices 110 and 120, for example. Packet detection processes such as frequency synchronization and timing correction may be executed on the received signals stored in the buffer 601, for example.

The known signal storage section 602 stores a known signal having the same pattern as the known signals generated by the known signal generator 203 illustrated in FIG. 2.

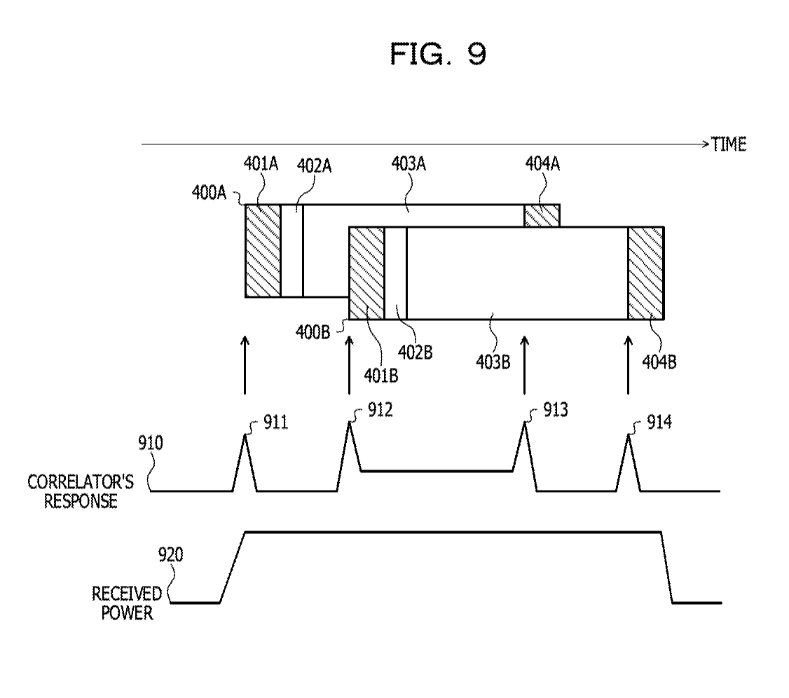

The correlator 603 calculates correlations (correlation values) between the received signals stored in the buffer 601 and the known signal stored in the known signal storage section 602. Then, the correlator 603 outputs a signal indicating the calculated correlations to the collision detector 605. The signal output from the correlator 603 to the collision detector 605 is described later (refer to, for example, FIG. 9).

The power detector 604 detects the power (amplitude) of the received signals stored in the buffer 601. Then, the power detector 604 outputs a signal indicating the detected power to the collision detector 605. The signal output from the power detector 604 to the collision detector 605 is described later (refer to, for example, FIG. 9).

The collision detector 605 detects the collision of the packets in the receiving device 130 based on the correlations indicated by the signal output from the correlator 603 and the power indicated by the signal output from the power detector 604. Then, the collision detector 605 outputs the result of detecting the collision of the packets to the channel estimator 606.

The channel estimator 606 executes the channel estimation based on the result, output from the collision detector 605, of detecting the collision of the packets and the received signals stored in the buffer 601. Then, the channel estimator 606 outputs channel estimation values indicating the results of the channel estimation to the signal separator 570 (refer to FIG. 5). In addition, the received signals stored in the buffer 601 are output to the signal separator 570.

(Hardware Configuration of Base Station According to First embodiment)

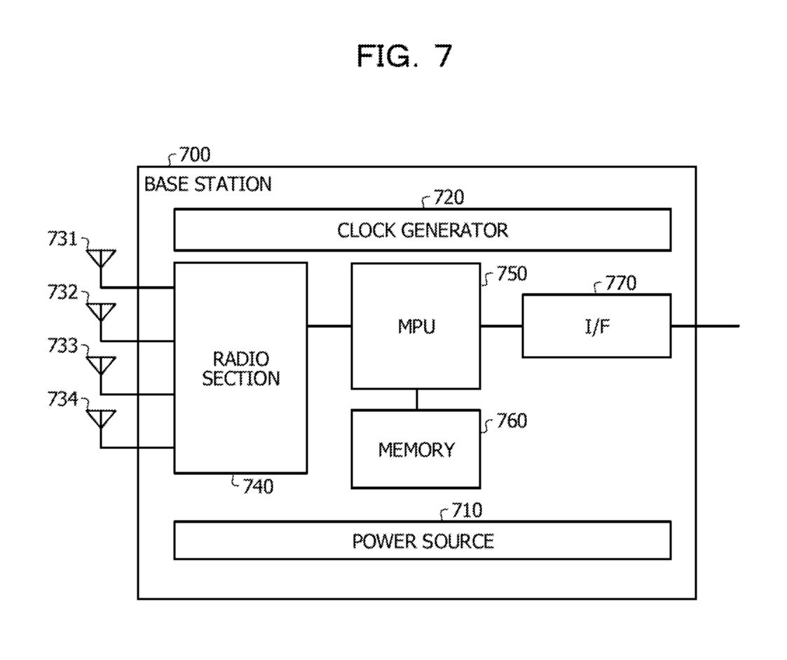

FIG. 7 illustrates an example of a hardware configuration of the base station according to the first embodiment. The base station 500 illustrated in FIG. 5 is achieved by a base station 700 illustrated in FIG. 7, for example. The base station 700 includes a power source 710, a clock generator 720, antennas 731 to 734, a radio section 740, an MPU 750, a memory 760, and an I/F 770.

The power source 710 supplies a voltage to each of the parts of the base station 700. The clock generator 720 generates an operation clock for the parts (for example, the MPU 750) of the base station 700. The antennas 731 to 734 have configurations corresponding to the antennas 511 to 514 illustrated in FIG. 5. The radio section 740 is a circuit configured to execute radio communication using the antennas 731 to 734 in accordance with control by the MPU 750. The amplifiers 521 to 524, the oscillator 530, the multipliers 541 to 544, and the digital converters 551 to 554 that are illustrated in FIG. 5 are included in the radio section 740, for example.

The MPU 750 controls the overall base station 700. The memory 760 includes a main memory and an auxiliary memory, for example. The main memory is a RAM, for example. The main memory is used as a work area of the MPU 750. The auxiliary memory is a nonvolatile memory such as a magnetic disk, an optical disc, or a flash memory, for example. The auxiliary memory stores various programs to be executed to cause the base station 700 to operate. The programs stored in the auxiliary memory are loaded into the main memory and executed by the MPU 750. The collision detecting and channel estimating sections 561 to 564, the signal separator 570, and the demodulator 580 that are illustrated in FIG. 5 are achieved by the MPU 750 and the main memory included in the memory 760, for example.

The I/F 770 is a communication interface configured to communicate with a communication device coupled to the base station 500 through a cable in accordance with control by the MPU 750, for example. For example, the base station 700 is coupled to a wired network and the I/F 770 communicates with the wired network.

(Process by Receiving Device According to First Embodiment)

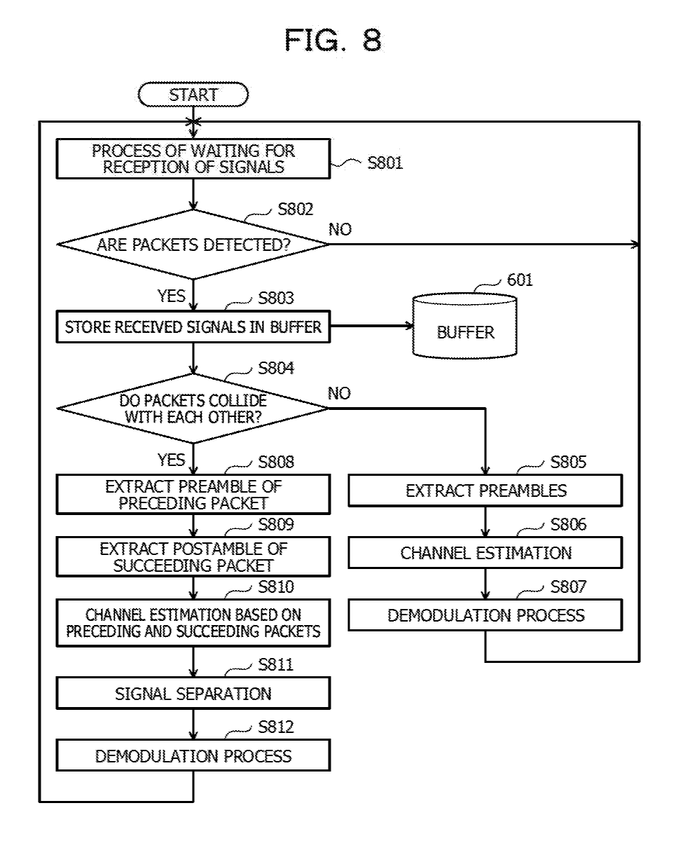

FIG. 8 is a flowchart of an example of a process to be executed by the receiving device according to the first embodiment. The receiving device 130 according to the first embodiment executes steps illustrated in FIG. 8, for example. First, the receiving device 130 executes a process of waiting for the reception of packets from other communication devices (for example, the transmitting device 110 and 120) (in step S801). Step S801 is executed by each of the collision detecting and channel estimating sections 561 to 564, for example.

Next, the receiving device 130 determines whether or not the receiving device 130 detected the packets from the other communication devices by the process of waiting for the reception in step S801 (in step S802). The packet detection is executed by detecting received power of radio waves by the receiving device 130 or detecting preambles by the receiving device 130, for example. Step S802 is executed by each of the collision detecting and channel estimating sections 561 to 564, for example.

If the receiving device 130 does not detect the packets (No in step S802), the receiving device 130 causes the process to return to step S801. If the receiving device 130 detected the packets (Yes in step S802), the receiving device 130 stores (temporarily stores) received signals in the buffer 601 (in step S803). Step S803 is executed by each of the collision detecting and channel estimating sections 561 to 564, for example.

Next, the receiving device 130 determines, based on the received signals stored in the buffer 601 in step S803, whether or not the packets collides with each other (in step S804). The determination of whether or not the packets collide with each other is described later. Step S804 is executed by each of the collision detecting and channel estimating sections 561 to 564, for example.

If the packets do not collide with each other (No in step S804), the receiving device 130 extracts preambles from the received signals stored in the buffer 601 (in step S805). Step S805 is executed by each of the collision detecting and channel estimating sections 561 to 564, for example.

Next, the receiving device 130 executes the channel estimation based on the preambles extracted in step S805 (in step S806). Step S806 is executed by each of the collision detecting and channel estimating sections 561 to 564, for example.

Next, the receiving device 130 executes a process of demodulating the packets included in the received signals stored in the buffer 601 based on results of the channel estimation executed in step S806 (in step S807) and causes the process to return to step S801. Step S807 is executed by the demodulator 580 based on the outputs of the collision detecting and channel estimating sections 561 to 564, for example.

If the packets collide with each other (Yes in step S804), the receiving device 130 extracts a preamble of a preceding packet from the received signals stored in the buffer 601 (in step S808). The preamble of the preceding packet is the preamble of the preceding packet among the colliding packets. For example, the receiving device 130 extracts, as the preamble, a known signal existing upon the initial peak of the output of the correlator 603 within a time period after the detection of the preceding packet in step S802. Step S808 is executed by each of the collision detecting and channel estimating sections 561 to 564, for example.

Next, the receiving device 130 extracts a postamble of a succeeding packet from the received signals stored in the buffer 601 (in step S809). The postamble of the succeeding packet is the postamble of the succeeding packet among the colliding packets. For example, the receiving device 130 extracts, as the postamble, a known signal existing upon a peak of the output of the correlator 603 within a time period from a certain time when a time period of the packet length elapses after the detection of the preceding packet to the time when a time period that is twice as long as the packet length elapses after the certain time. Step S809 is executed by each of the collision detecting and channel estimating sections 561 to 564, for example.

Next, the receiving device 130 executes the channel estimation based on the preamble, extracted in step S808, of the preceding packet and executes the channel estimation based on the postamble, extracted in step S809, of the succeeding packet (in step S810). Step S810 is executed by each of the collision detecting and channel estimating sections 561 to 564, for example.

Next, the receiving device 130 executes, based on the results of the channel estimation executed in step S810, the signal separation so as to separate and extract the colliding packets from the received signals stored in the buffer 601 (in step S811). For example, the receiving device 130 executes calculation for the signal separation on overlapping portions of the packets among portions that are included in the received signals stored in the buffer 601 and are not known signals of the received signals stored in the buffer 601.

In addition, the receiving device 130 does not execute the calculation for the signal separation on portions that are included in the packets of the received signals stored in the buffer 601 and do not overlap each other. A method of identifying the overlapping portions of the packets of the received signals is described later. In the signal separation executed in step S811, various processes such as MLD and MMSE may be used, for example. Step S811 is executed by the signal separator 570 based on the outputs of the collision detecting and channel estimating sections 561 to 564, for example.

Next, the receiving device 130 executes, based on the results of the signal separation executed in step S811, the process of demodulating the packets included in the received signals stored in the buffer 601 (in step S812) and causes the process to return to step S801. Step S812 is executed by the demodulator 580, for example.

(Method of Identifying Overlapping Portions of Packets)

The method of identifying the overlapping portions of the packets of the received signals is described. The receiving device 130 identifies the overlapping portions of the packets based on the position of the preamble of the preceding packet, the known packet length, and the postamble of the succeeding packet, for example. For example, the heads of the overlapping portions of the packets exist at a time that precedes the tail of the postamble of the succeeding packet by the packet length. In addition, the ends of the overlapping portions of the packets exist at a time that succeeds the head of the preamble of the preceding packet by the packet length.

Alternatively, codes that indicate the packet lengths and the positions of the payloads may be inserted near the preambles and the postambles. Thus, the receiving device 130 identifies, based on the codes indicating the packet lengths and the positions of the payloads, the overlapping portions of the packets and the portions that are included in the packets and do not overlap.

Alternatively, if there are four peaks in the output of the correlator 603 within a time period that is twice as long as the packet length, the receiving device 130 may identify, as the overlapping portions of the packets, portions between two peaks that are among the four peaks and are not the initial and last peaks among the four peaks. In addition, the method of identifying the overlapping portions of the packets of the received signals is not limited to this, and various methods such as a method using a change in the output received power 920 (refer to FIG. 9) may be used.

(Collision of Packets in Case where Packet Lengths are Fixed in First Embodiment)

FIG. 9 illustrates an example of the collision of the packets in a case where the packet lengths are fixed in the first embodiment. In FIG. 9, the abscissa indicates time. Packets 400A and 400B illustrated in FIG. 9 are transmitted by the transmitting devices 110 and 120. The formats of the packets 400A and 400B are the same as or similar to that of the packet 400 illustrated in FIG. 4.

Each of preambles 401A and 401B corresponds to the preamble 401 illustrated in FIG. 4. Each of headers 402A and 402B corresponds to the header 402 illustrated in FIG. 4. Each of payloads 403A and 403B corresponds to the payload 403 illustrated in FIG. 4. Each of postambles 404A and 404B corresponds to the postamble 404 illustrated in FIG. 4.

In the example illustrated in FIG. 9, the packet 400A transmitted by the transmitting device 110 reaches the receiving device 130 as a preceding packet, and the packet 400B transmitted by the transmitting device 120 reaches the receiving device 130 as a succeeding packet. In addition, the example illustrated in FIG. 9 describes a case where the length L1 of the packet transmitted by the transmitting device 110 and the length L2 of the packet transmitted by the transmitting device 120 are fixed and equal to each other (L1=L2).

A correlator's response 910 illustrated in FIG. 9 indicates the signal output from the correlator 603 illustrated in FIG. 6 to the collision detector 605. Specifically, the correlator's response 910 indicates correlations between the received signals stored in the buffer 601 and the known signal stored in the known signal storage section 602. Since a signal that has low mutual correlations with other signals are used as the known signal, the correlator's response 910 has large values at portions matching the preambles and the postambles.

Thus, the times when the peaks occur in the correlator's response 910 are when the receiving device 130 detects the preambles and the postambles. In the example illustrated in FIG. 9, the peaks 911 to 914 that correspond to the preamble 401A, the preamble 401B, the postamble 404A, and the postamble 404B occur.

The received power 920 illustrated in FIG. 9 indicates the signal output from the power detector 604 illustrated in FIG. 6 to the collision detector 605. Specifically, the received power 920 indicates the power (amplitude) of the received signals stored in the buffer 601. A response at a certain level or higher is continuously obtained from the received power 920 after the detection of the preceding packet. In the example illustrated in FIG. 9, the received power 920 rises at a time corresponding to the head of the preceding packet 400A and falls at a time corresponding to the tail of the succeeding packet 400B.

The collision detector 605 illustrated in FIG. 6 detects the collision of the packets in the receiving device 130 based on the peaks of the correlator's response 910 and the received power 920.

(Detection Process by Collision Detector According to First Embodiment in Case where Packet Lengths are Fixed)

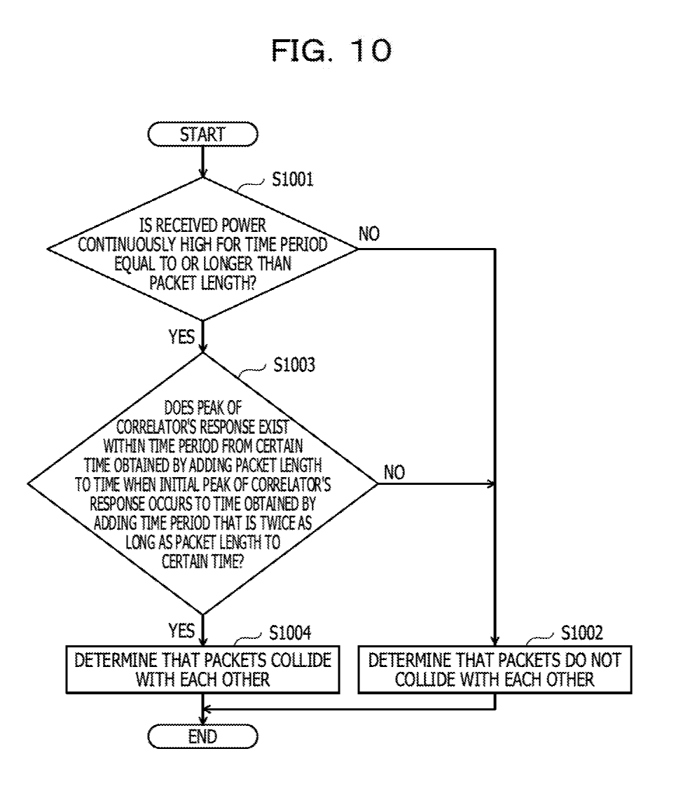

FIG. 10 is a flowchart of an example of the detection process to be executed by the collision detector according to the first embodiment in the case where the packet lengths are fixed. If the lengths of the packets transmitted by the transmitting devices 110 and 120 are fixed, the collision detector 605 illustrated in FIG. 6 executes steps illustrated in FIG. 10 in step S804 illustrated in FIG. 8, for example.

First, the collision detector 605 determines whether or not the received power 920 indicated by the signal output from the power detector 604 is continuously high for a time period that is equal to or longer than the packet length (in step S1001). A state in which the received power 920 is high is a state in which the received power 920 exceeds a predetermined value, for example. The packet length is known to the collision detector 605, for example. Alternatively, the collision detector 605 may identify the packet length from headers (for example, the headers 402 illustrated in FIG. 4) included in the received signals stored in the buffer 601, for example. In addition, in the determination of whether or not the received power 920 is continuously high, a short-term reduction in the power, such as a dip in a fading environment, may be excluded, for example. For example, the collision detector 605 calculates a moving average of instantaneous power of the signal output from the power detector 604. Thus, whether or not the received power 920 is continuously high for the time period equal to or longer than the packet length is determined while the short-term reduction in the power, such as the dip in the fading environment, is excluded.

If the received power is not continuously high for the time period (No in step S1001), the collision detector 605 determines that the packets do not collide with each other (in step S1002) and terminates the detection process.

If the received power is continuously high for the time period (Yes in step S1001), the collision detector 605 causes the process to proceed to step S1003. Specifically, the collision detector 605 determines whether or not the correlator's response 910 has a peak within a time period from a certain time obtained by adding the packet length to the time when the initial peak of the correlator's response 910 occurs to a time obtained by adding a time period that is twice as long as the packet length to the certain time (in step S1003). The time period from the certain time obtained by adding the packet length to the time when the initial peak of the correlator's response 910 occurs to the time obtained by adding the time period that is twice as long as the packet length to the certain time is the time period from the certain time when the time period that is equal to the packet length elapses after the initial peak of the correlator's response 910 to the time when the time period that is twice as long as the packet length elapses after the certain time.

The initial peak of the correlator's response 910 is the peak 911 that is among the peaks of the correlator's response 910 illustrated in FIG. 9 and occurs immediately after the received power 920 rises, for example. The time when the time period that is equal to the packet length elapses after the initial peak of the correlator's response 910 is the time corresponding to the end of the packet 400A illustrated in FIG. 9, for example.

If the peak does not exist within the time period from the certain time obtained by adding the packet length to the time when the initial peak of the correlator's response 910 occurs to the time obtained by adding the time period that is twice as long as the packet length to the certain time (No in step S1003), the collision detector 605 causes the process to proceed to step S1002 and determines that the packets do not collide with each other. If the peak exists (Yes in step S1003), the collision detector 605 determines that the packets collide with each other (in step S1004) and terminates the detection process.

In this manner, if the lengths of the packets transmitted by the transmitting devices 110 and 120 are fixed and the following conditions (1) and (2) are satisfied, the collision detector 605 determines that the packets collide with each other.

(1) The power of the received signals continuously exceeds the predetermined value for a time period equal to or longer than the packet length.

(2) A signal that has the same pattern as preambles and postambles exists within a time period between a certain time when a time period that is equal to the packet length elapses after the head of a preceding packet and the time when a time period that is twice as long as the packet length elapses after the certain time.

The orders that steps S1001 and S1003 are executed may be switched with each other.

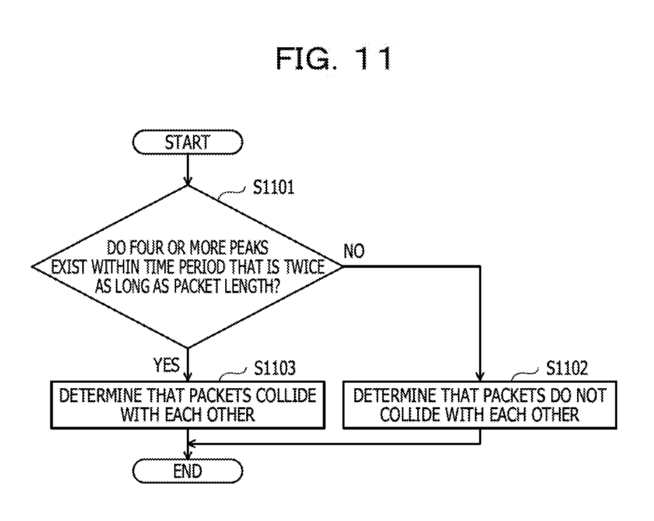

FIG. 11 is a flowchart of another example of the detection process to be executed by the collision detector according to the first embodiment in the case where the packet lengths are fixed. In the case where the lengths of the packets transmitted by the transmitting devices 110 and 120 are fixed, the collision detector 605 illustrated in FIG. 6 may execute steps illustrated in FIG. 11 in step S804 illustrated in FIG. 8, for example. First, the collision detector 605 determines whether or not four or more peaks exist in the correlator's response 910 within a time period that is twice as long as the packet length (in step S1101).

If the collision detector 605 determines that four or more peaks do not exist within the time period that is twice as long as the packet length (No in step S1101), the collision detector 605 determines that the packets do not collide with each other (in step S1102) and terminates the detection process.

If the collision detector 605 determines that four or more peaks exist within the time period that is twice as long as the packet length (Yes in step S1101), the collision detector 605 determines that the packets collide with each other (in step S1103) and terminates the detection process.

In the case where the lengths of the packets transmitted by the transmitting devices 110 and 120 are fixed and the following condition (1) is satisfied, the collision detector 605 may determine that the packets collide with each other.

(1) Four or more signals that have the same pattern as preambles and postambles are exist within a time period that is twice as long as the packet length.

In this case, the power detector 604 illustrated in FIG. 6 may be omitted.

(Collision of Packets in Case where Packet Lengths are Variable in First Embodiment)

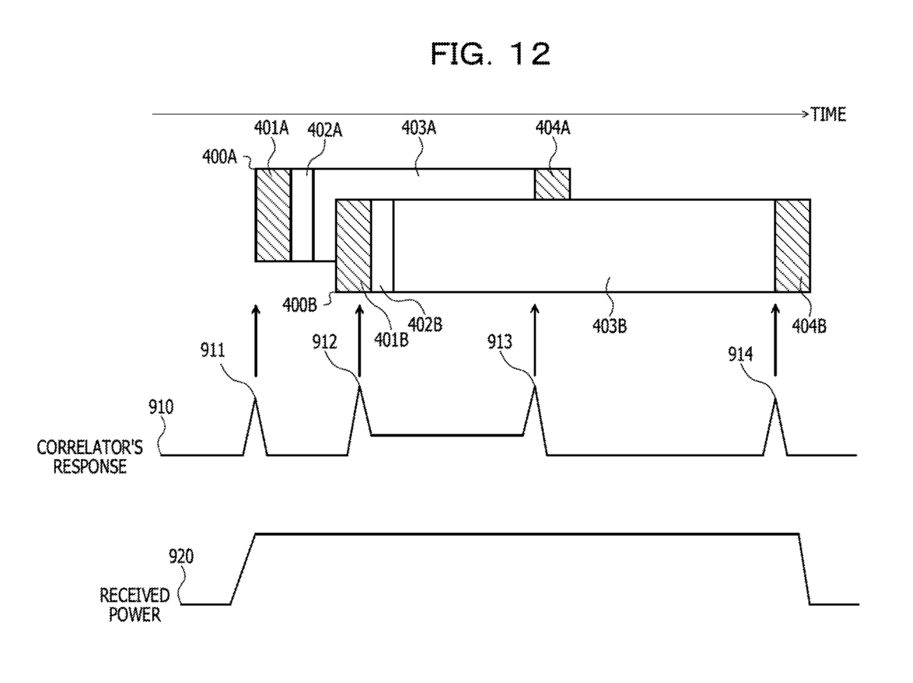

FIG. 12 illustrates an example of the collision of the packets in a case where the packet lengths are variable in the first embodiment. Parts that are illustrated in FIG. 12 and are the same as or similar to those illustrated in FIG. 9 are indicated by the same reference numbers and symbols as those illustrated in FIG. 9 and a description thereof is omitted. The example illustrated in FIG. 12 describes a case where the length L1 of the packet 400A transmitted by the transmitting device 110 and the length L2 of the packet 400B transmitted by the transmitting device 120 are variable and not known to the receiving device 130.

In the example illustrated in FIG. 12, the length L1 of the packet 400A transmitted by the transmitting device 110 is shorter than the length L2 of the packet 400B transmitted by the transmitting device 120. In addition, the postamble 404B of the succeeding packet 400B succeeds the postamble 404A of the preceding packet 400A.

If the packet lengths are variable and at least the length of the preceding packet 400A is not recognized, it is difficult to determine whether or not the packets collide with each other. Thus, the collision detecting and channel estimating section 600 executes the correlation process on the preambles and acquires, from the header 402A received after the preamble, information indicating the length of the packet 400A.

(Detection Process by Collision Detector According to First Embodiment in Case where Packet Lengths are Variable)

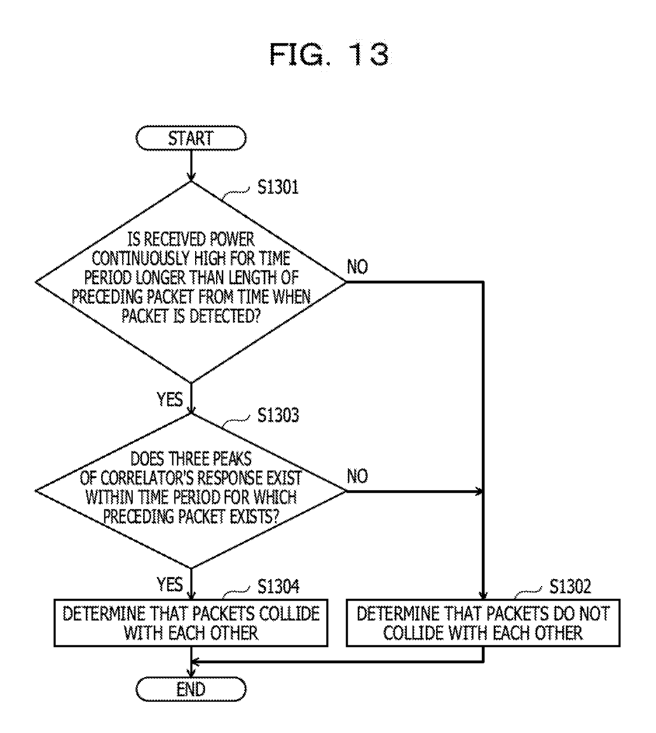

FIG. 13 is a flowchart of an example of the detection process to be executed by the collision detector according to the first embodiment in the case where the packet lengths are variable. In the case where the lengths of the packets transmitted by the transmitting devices 110 and 120 are variable, the collision detector 605 illustrated in FIG. 6 executes steps illustrated in FIG. 13 in step S804 illustrated in FIG. 8, for example.

First, the collision detector 605 determines whether or not the received power 920 (for example, the moving average of the instantaneous power) is continuously high for a time period longer than the length of the preceding packet after the detection of the preceding packet (in step S1301). The length of the preceding packet is acquired from the header of the preceding packet, as described above. If the received power 920 is not continuously high for the time period (No in step S1301), the collision detector 605 determines that the packets do not collide with each other (in step S1302) and terminates the detection process.

If the received power 920 is continuously high for the time period (Yes in step S1301), the collision detector 605 determines whether or not the number of peaks existing in the correlator's response 910 is three within a time period for which the preceding packet exists (in step S1303). If the number of the peaks existing in the correlator's response is not three (No in step S1303), the collision detector 605 causes the process to proceed to step S1302 and determines that the packets do not collide with each other.

If the number of the peaks existing in the correlator's response is three (Yes in step S1303), the collision detector 605 determines that the packets collide with each other (in step S1304) and terminates the detection process. In this case, the receiving device 130 extracts, as the postamble, a known signal existing upon a peak that is included in the correlator's response 910 and exists near the end of a time period for which the received power 920 is high, and the receiving device 130 executes the channel estimation on the preceding packet and the succeeding packet based on the preambles and the postambles.

In this manner, if the packet lengths are variable and the following conditions (1) and (2) are satisfied, the collision detector 605 determines that the packets collide with each other based on the length of the preceding packet that is indicated by the header included in the preceding packet.

(1) The power of the received signals continuously exceeds the predetermined value for the time period of the length of the preceding packet or longer.

(2) Three signals that have the same pattern as preambles and postambles exist within the time period for which a preceding packet exists.

The orders that steps S1301 and S1303 are executed may be switched with each other.

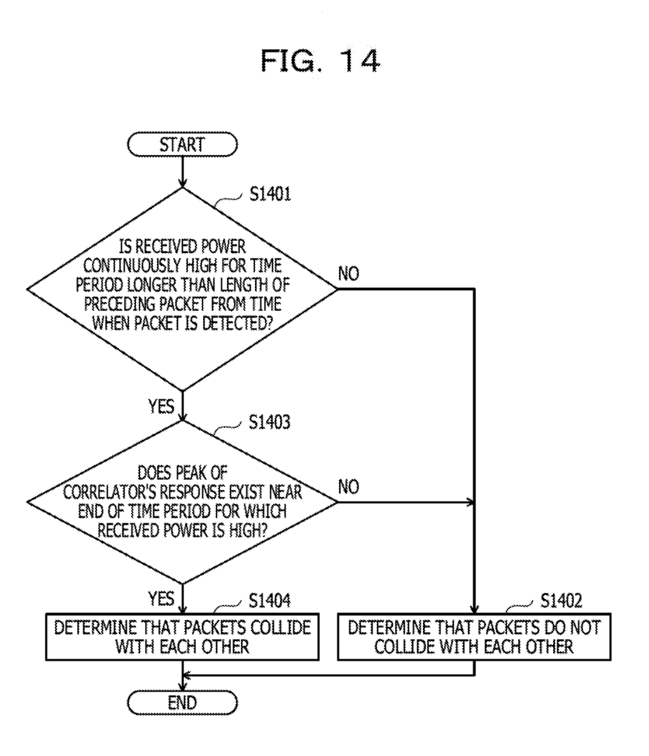

FIG. 14 is a flowchart of another example of the detection process to be executed by the collision detector according to the first embodiment in the case where the packet lengths are variable. If the lengths of the packets transmitted by the transmitting devices 110 and 120 are variable, the collision detector 605 illustrated in FIG. 6 may execute steps illustrated in FIG. 14 in step S804 illustrated in FIG. 8, for example.

First, the collision detector 605 determines whether or not the received power 920 (for example, the moving average of the instantaneous power) is continuously high for a time period longer than the length of the preceding packet after the detection of the preceding packet (in step S1401). If the received power 920 is not continuously high for the time period (No in step S1401), the collision detector 605 determines that the packets do not collide with each other (in step S1402) and terminates the detection process.

If the received power 920 is continuously high for the time period (Yes in step S1401), the collision detector 605 determines whether or not a peak of the correlator's response 910 exists near the end of the time period for which the received power 920 (for example, the moving average of the instantaneous power) is high (in step S1403). If the collision detector 605 determines that the peak does not exist (No in step S1403), the collision detector 605 causes the process to proceed to step S1402 and determines that the packets do not collide with each other.

If collision detector 605 determines that the peak exists (Yes in step S1403), the collision detector 605 determines that the packets collide with each other (in step S1404) and terminates the detection process. In this case, the receiving device 130 extracts, as the postamble, a known signal existing upon the peak that is included in the correlator's response 910 and exists near the end of the time period for which the received power 920 is high, and the receiving device 130 executes the channel estimation on the preceding packet and the succeeding packet based on the preambles and the postambles.

In this manner, if the packet lengths are variable and the following conditions (1) and (2) are satisfied, the collision detector 605 may determine that the packets collide with each other based on the length of the preceding packet that is indicated by the header included in the preceding packet.

(1) The power of the received signals continuously exceeds the predetermined value for the time period of the length of a preceding packet or longer.

(2) A signal that has the same pattern as preambles and postambles exists near the end of the time period for which the power of the received signals continuously exceeds the predetermined value.

The orders that steps S1401 and S1403 are executed may be switched with each other.

(Other Example of Collision of Packets in Case where Packet Lengths are Variable in First Embodiment)

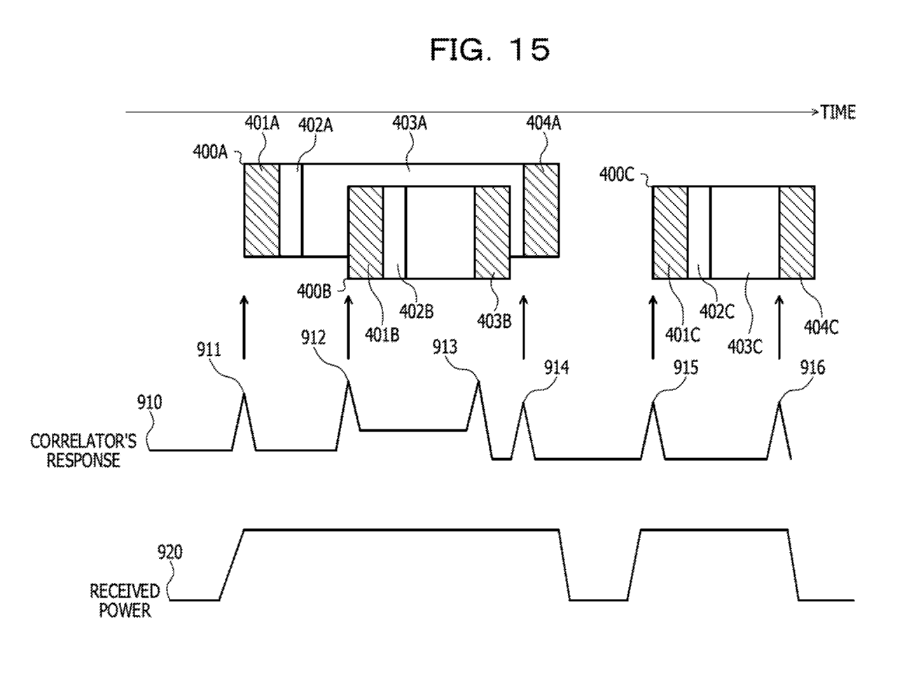

FIG. 15 illustrates another example of the collision of the packets in the case where the packet lengths are variable in the first embodiment. Parts that are illustrated in FIG. 15 and the same as or similar to those illustrated in FIG. 12 are indicated by the same reference numbers and symbols as those illustrated in FIG. 12 and a description thereof is omitted. A packet 400C illustrated in FIG. 15 is in a format that is the same as or similar to the packet 400 illustrated in FIG. 4.

A preamble 401C corresponds to the preamble 401 illustrated in FIG. 4. A header 402C corresponds to the header 402 illustrated in FIG. 4. A payload 403C corresponds to the payload 403 illustrated in FIG. 4. A postamble 404C corresponds to the postamble 404 illustrated in FIG. 4. In the example illustrated in FIG. 15, peaks 915 and 916 that correspond to the preamble 401C and the postamble 404C occur in the correlator's response 910.

As illustrated in FIG. 15, if a time period for which the succeeding packet 400B exists is included in a time period for which the preceding packet 400A exists, it is difficult to execute the channel estimation on the packets 400A and 400B. In this case, the receiving device 130 outputs an error as the result of demodulating the packets, for example.

According to the first embodiment, the transmitting devices 110 and 120 insert the preambles and the postambles in the packets to be transmitted. Thus, the receiving device 130 detects the collision of the packets based on the timings of detecting the preambles and the postambles and the lengths of the transmitted packets.

In addition, if the receiving device 130 detects the collision of the packets, the receiving device 130 executes the channel estimation based on the preamble of the preceding packet among the colliding packets and executes the channel estimation based on the postamble of the succeeding packet among the colliding packets. By the channel estimation, the receiving device 130 obtains channel estimation values for the colliding packets.

Then, the receiving device 130 executes the signal separation on colliding portions of the colliding packets based on the obtained channel estimation values. By the signal separation, the receiving device 130 demodulates the packets obtained by the signal separation. Thus, the receiving device 130 receives the colliding packets even if the packets transmitted by the transmitting devices 110 and 120 collide with each other.

### Second Embodiment

A second embodiment describes parts that are different from the first embodiment. The first embodiment describes the case where the packets that use the known signals having the same pattern as the preambles and the postambles are transmitted. On the other hand, the second embodiment describes a case where the packets that use known signals having different patterns as preambles and postambles are transmitted.

(Transmitting Devices According to Second Embodiment)

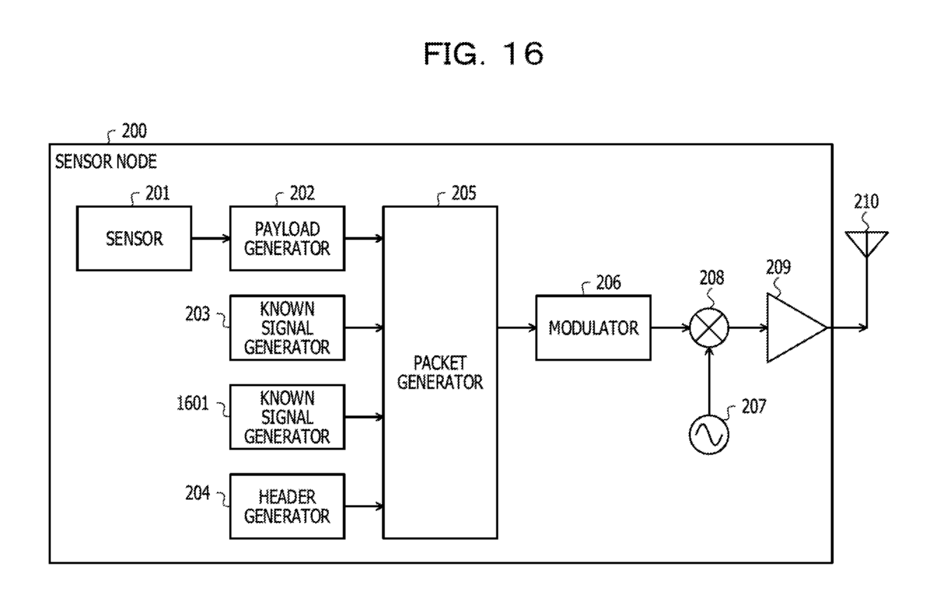

FIG. 16 illustrates an example of the transmitting devices according to the second embodiment. Parts that are illustrated in FIG. 16 and are the same as or similar to those illustrated in FIG. 2 are indicated by the same reference numerals as those illustrated in FIG. 2 and a description thereof is omitted. In the second embodiment, each of the transmitting devices 110 and 120 illustrated in FIG. 1 is achieved by a sensor node 200 illustrated in FIG. 16, for example. As illustrated in FIG. 16, the sensor node 200 according to the second embodiment has the configuration of the sensor node 200 illustrated in FIG. 2 and includes a known signal generator 1601. The known signal generator 1601 is achieved by the MPU 305 illustrated in FIG. 3, for example.

The known signal generator 1601 generates a known signal having a pattern different from the pattern of a known signal generated by the known signal generator 203 and outputs the generated known signal to the packet generator 205. The known signal generated by the known signal generator 1601 has low correlations with other signals such as the payload and the header and has a low correlation with the known signal generated by the known signal generator 203, for example.

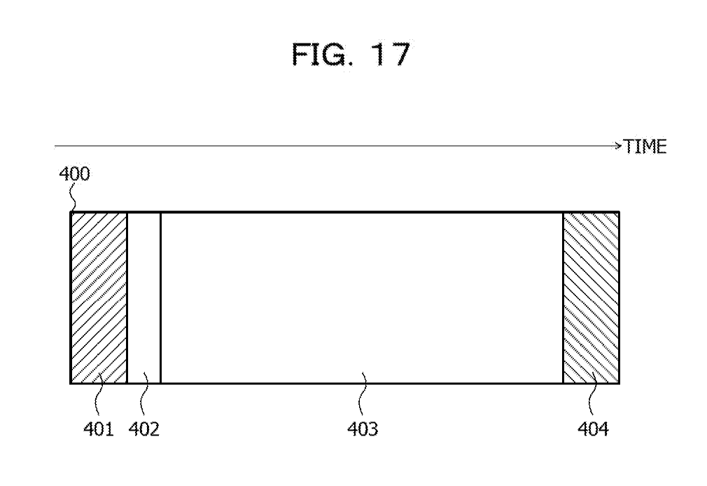

The packet generator 205 generates a packet based on the payload output from the payload generator 202, the known signals output from the known signal generators 203 and 1601, and the header output from the header generator 204. In this case, the packet generator 205 uses the known signal output from the known signal generator 203 as a preamble of the packet and uses the known signal output from the known signal generator 1601 as a postamble of the packet. The packet generated by the packet generator 205 according to the second embodiment is described below (refer to, for example, FIG. 17).

(Packet Generated by Packet Generator According to Second Embodiment)

FIG. 17 illustrates an example of the packet generated by the packet generator according to the second embodiment. Parts that are illustrated in FIG. 17 and are the same as or similar to those illustrated in FIG. 4 are indicated by the same reference numbers as those illustrated in FIG. 4 and a description thereof is omitted. The packet generator 205 of the sensor node 200 illustrated in FIG. 16 generates a packet 400 illustrated in FIG. 17, for example.

A preamble 401 is the known signal output from the known signal generator 203 illustrated in FIG. 16 to the packet generator 205. A postamble 404 is the known signal output from the known signal generator 1601 illustrated in FIG. 16 to the packet generator 205. In the second embodiment, the known signals that have different patterns are used as the preamble 401 and the postamble 404.

(Collision Detecting and Channel Estimating Sections According to Second Embodiment)

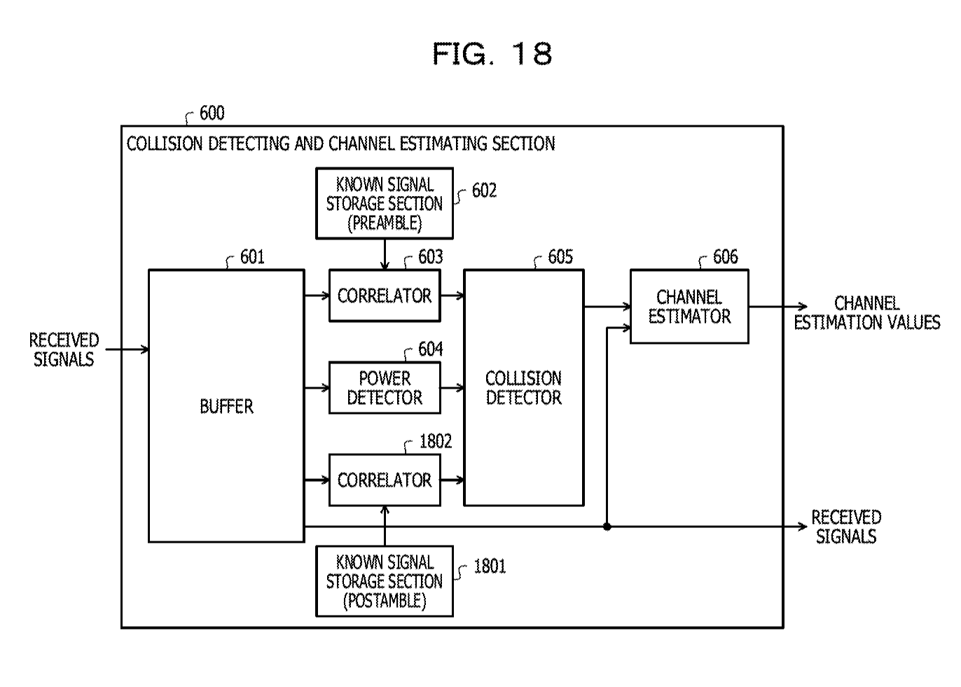

FIG. 18 illustrates an example of the collision detecting and channel estimating sections according to the second embodiment. Parts that are illustrated in FIG. 18 and are the same as or similar to those illustrated in FIG. 6 are indicated by the same reference numbers as those illustrated in FIG. 6 and a description thereof is omitted. In the second embodiment, each of the collision detecting and channel estimating sections 561 to 564 illustrated in FIG. 5 is achieved by a collision detecting and channel estimating section 600 illustrated in FIG. 18, for example.

The collision detecting and channel estimating section 600 illustrated in FIG. 18 has the configuration of the collision detecting and channel estimating section 600 illustrated in 6 and includes a known signal storage section 1801 and a correlator 1802. The known signal storage section 1801 stores a known signal having the same pattern as the known signal generated by the known signal generator 1601 illustrated in FIG. 16.

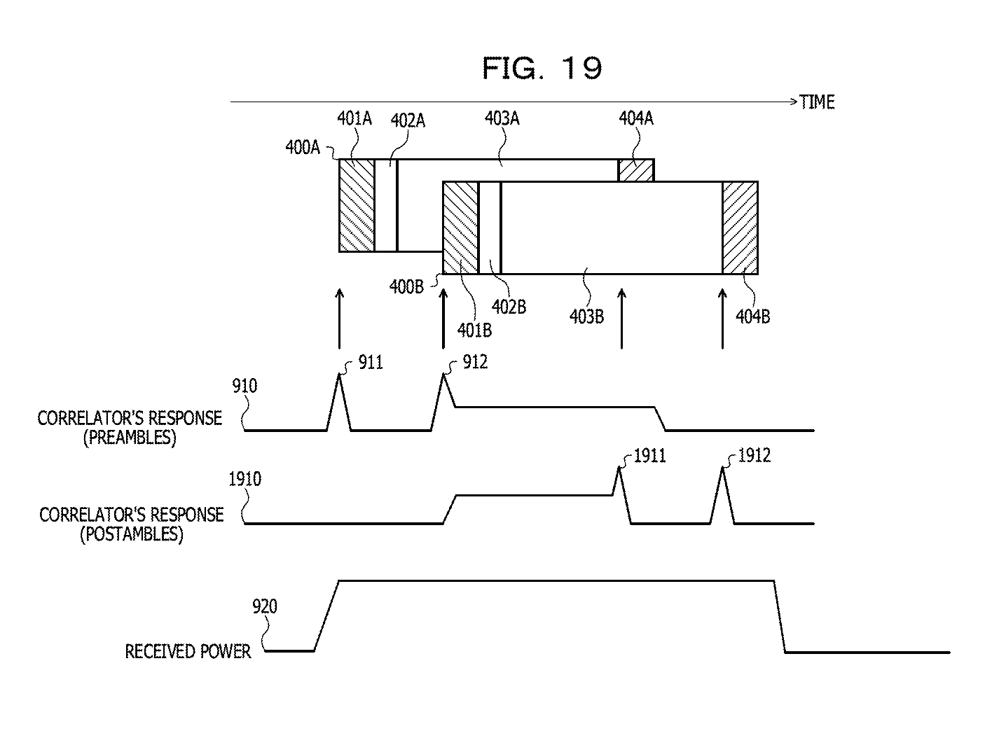

The correlator 1802 calculates correlations between the received signals stored in the buffer 601 and the known signal stored in the known signal storage section 1801. Then, the correlator 1802 outputs a signal indicating the calculated correlations to the collision detector 605. The signal output by the correlator 1802 to the collision detector 605 is described later (refer to, for example, FIG. 19).

The collision detector 605 detects the collision of the packets in the receiving device 130 based on the correlations indicated by the signals output from the correlators 603 and 1802 and the power indicated by the signal output from the power detector 604.

(Collision of Packets in Case where Packet Lengths are Fixed in Second Embodiment)

FIG. 19 illustrates an example of the collision of the packets in the case where the packet lengths are fixed in the second embodiment. Parts that are illustrated in FIG. 19 and are the same as or similar to those illustrated in FIG. 9 are indicated by the same reference numbers and symbols as those illustrated in FIG. 9 and a description thereof is omitted. The example illustrated in FIG. 19 describes the case where the length L1 of the packet transmitted by the transmitting device 110 and the length L2 of the packet transmitted by the transmitting device 120 are fixed and equal to each other (L1=L2).

A correlator's response 1910 illustrated in FIG. 19 indicates the signal output from the correlator 1802 illustrated in FIG. 18 to the collision detector 605. Specifically, the correlator's response 1910 indicates the correlations between the received signals stored in the buffer 601 and the known signal stored in the known signal storage section 1801.

The correlator's response 910 has large values (peaks) at portions matching the preambles. Thus, the times when the peaks occur in the correlator's response 910 are when the receiving device 130 detects the preambles. In the example illustrated in FIG. 19, the peaks 911 and 912 that correspond to the preambles 401A and 401B occur in the correlator's response 910.

The correlator's response 1910 has large values (peaks) at portions matching the postambles. Thus, the times when the peaks occur in the correlator's response 1910 are when the receiving device 130 detects the postambles. In the example illustrated in FIG. 19, the peaks 1911 and 1912 that correspond to the postambles 404A and 404B occur in the correlator's response 1910.

The collision detector 605 illustrated in FIG. 18 detects the collision of the packets based on the peaks of the correlator's responses 910 and 1910 and the received power 920.

(Detection Process by Collision Detector According to Second Embodiment in Case where Packet Lengths are Fixed)

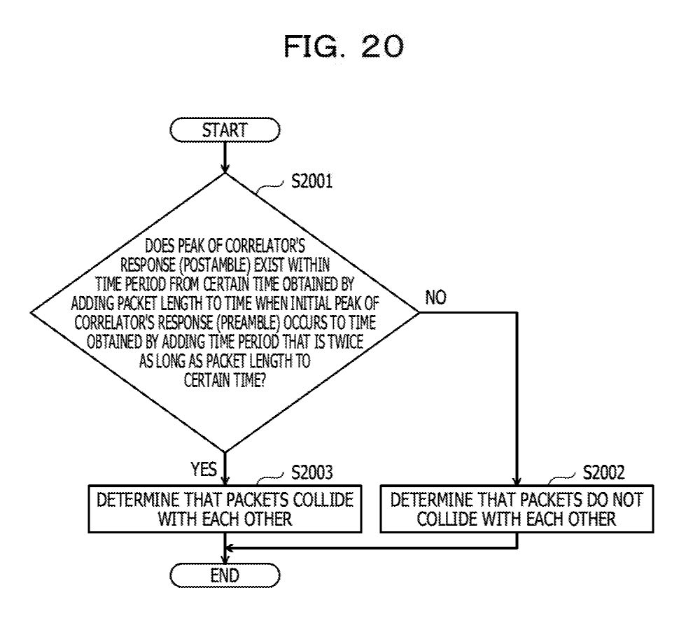

FIG. 20 is a flowchart of an example of the detection process to be executed by the collision detector according to the second embodiment in the case where the packet lengths are fixed. In the case where the lengths of the packets transmitted by the transmitting devices 110 and 120 are fixed, the collision detector 605 illustrated in FIG. 18 executes steps illustrated in FIG. 20 in step S804 illustrated in FIG. 8, for example.

First, the collision detector 605 determines whether or not a peak that corresponds to the postamble exists in the correlator's response 1910 within a time period from a certain time obtained by adding the packet length to the time when the initial peak, corresponding to the preamble, of the correlator's response 910 occurs to a time obtained by adding a time period that is twice as long as the packet length to the certain time (in step S2001). The time period from the certain time to the time obtained by adding the time period that is twice as long as the packet length to the certain time is the time period between the certain time when the time period of the packet length elapses after the initial peak, corresponding to the preamble, of the correlator's response 910 and the time when the time period that is twice as long as the packet length elapses after the certain time.

If the collision detector 605 determines that the peak does not exist (No in step S2001), the collision detector 605 determines that the packets do not collide with each other (in step S2002) and terminates the detection process. If the collision detector 605 determines that the peak exists (Yes in step S2001), the collision detector 605 determines that the packets collide with each other (in step S2003) and terminates the detection process.

In this case, the receiving device 130 executes the channel estimation based on the initial preamble and the last postamble and executes the signal separation process on overlapping portions of the packets in the same manner as the first embodiment. The aforementioned various identification methods may be used as the method of identifying the overlapping portions of the packets. Alternatively, the receiving device 130 may identify, as the overlapping portions of the packets, a time period between the second peak, corresponding to the preamble, of the correlator's response 910 and the first peak, corresponding to the postamble, of the correlator's response 1910.

If the lengths of the packets transmitted by the transmitting devices 110 and 120 are fixed and the following condition (1) is satisfied, the collision detector 605 determines that the packets collide with each other.

(1) A postamble exists within a time period between a certain time when a time period of the packet length elapses after a preamble of a preceding packet and the time when a time period that is twice as long as the packet length elapses after the certain time.

(Collision of Packets in Case where Packet Lengths are Variable in Second Embodiment)

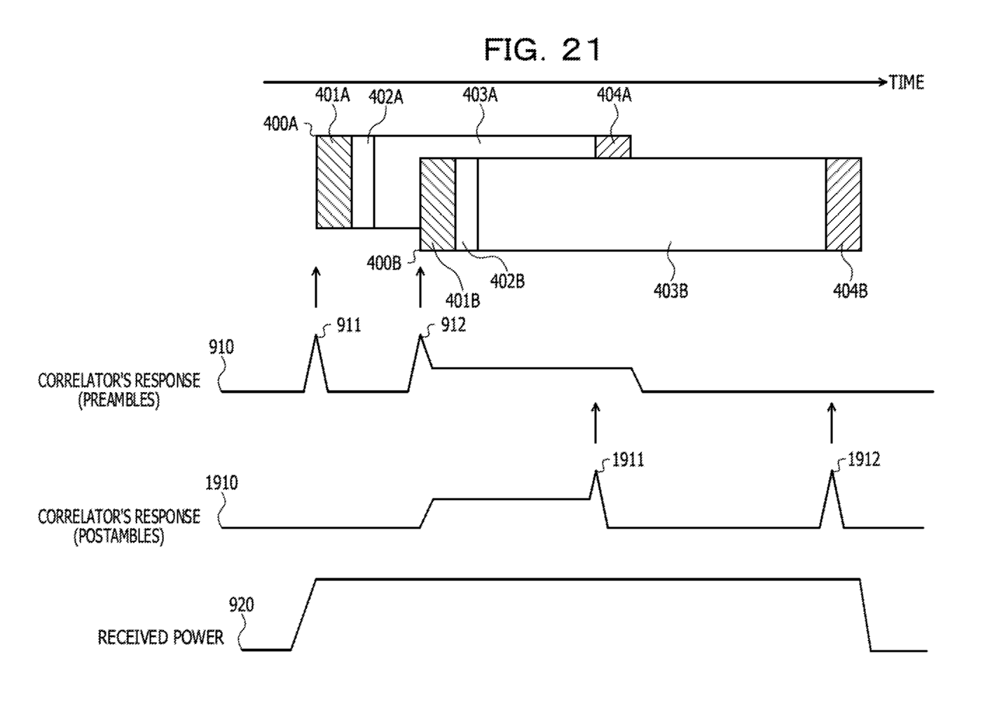

FIG. 21 illustrates an example of the collision of the packets in the case where the packet lengths are variable in the second embodiment. Parts that are illustrated in FIG. 21 and are the same as or similar to those illustrated in FIG. 19 are indicated by the same reference numbers and symbols as those illustrated in FIG. 19 and a description thereof is omitted. The example illustrated in FIG. 21 describes the case where the length L1 of the packet 400A transmitted by the transmitting device 110 and the length L2 of the packet 400B transmitted by the transmitting device 120 are variable and not known to the receiving device 130.

If the packet lengths are variable and at least the length of the preceding packet 400A is not recognized, it is difficult to determine whether or not the packets collide with each other. Thus, the collision detecting and channel estimating section 600 executes the correlation process on the preambles and acquires information indicating the length of the packet 400A from the header 402A received after the preamble.

(Detection Process by Collision Detector According to Second Embodiment in Case where Packet Lengths are Variable)

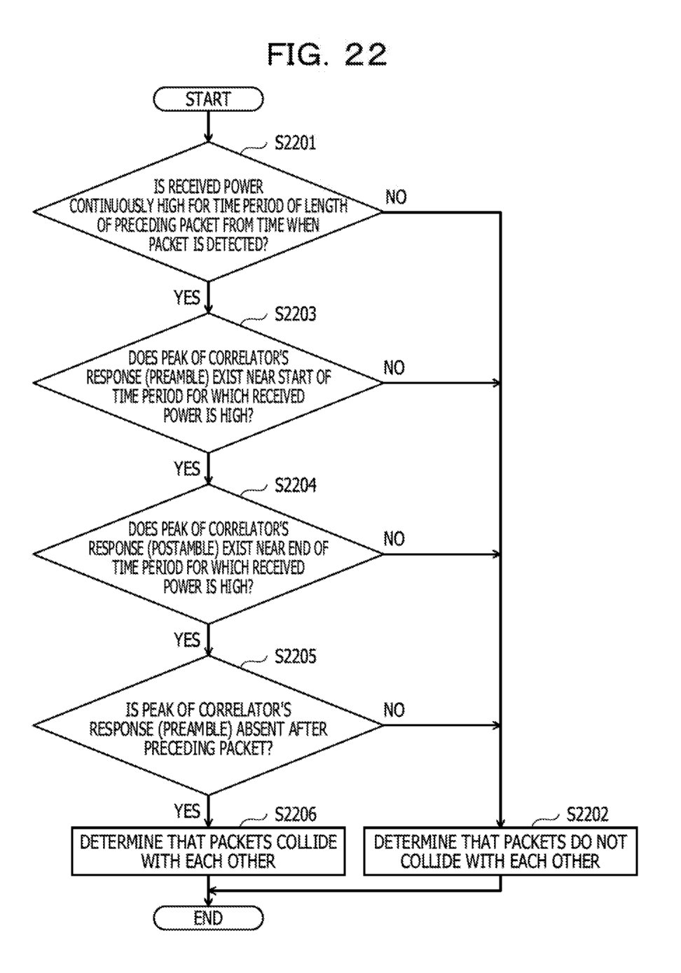

FIG. 22 is a flowchart of an example of the detection process to be executed by the collision detector according to the second embodiment in the case where the packet lengths are variable. In the case where the lengths of the packets transmitted by the transmitting devices 110 and 120 are variable, the collision detector 605 illustrated in FIG. 18 executes steps illustrated in FIG. 22 in step S804 illustrated in FIG. 8, for example.

First, the collision detector 605 determines whether or not the received power 920 (for example, the moving average of the instantaneous power) is continuously high for a time period longer than the length of the preceding packet after the detection of the preceding packet (in step S2201). The time when the packet is detected is when the initial peak, corresponding to the preamble, of the correlator's response 910 occurs. The length of the preceding packet is acquired from the header of the preceding packet, as described above.

If the received power 920 is not continuously high (No in step S2201), the collision detector 605 determines that the packets do not collide with each other (in step S2202) and terminates the detection process. If the received power 920 is continuously high (Yes in step S2201), the collision detector 605 determines whether or not the peak, corresponding to the preamble, of the correlator's response 910 exists near the start of the time period for which the received power 920 (for example, the moving average of the instantaneous power) is high (in step S2203).

If the collision detector 605 determines that the peak does not exist (No in step S2203), the collision detector 605 causes the process to proceed to step S2202 and determines that the packets do not collide with each other. If the collision detector 605 determines that the peak exists (Yes in step S2203), the collision detector 605 determines whether or not the peak, corresponding to the postamble, of the correlator's response 1910 exists near the end of the time period for which the received power 920 is high (in step S2204).

If the collision detector 605 determines that the peak does not exist (No in step S2204), the collision detector 605 causes the process to proceed to step S2202 and determines that the packets do not collide with each other. If the collision detector 605 determines that the peak exists (Yes in step S2204), the collision detector 605 determines whether or not the peak, corresponding to the preamble, of the correlator's response 910 is absent after the preceding packet (in step S2205). For example, the collision detector 605 determines whether or not the peak of the correlator's response 910 is absent after the preceding packet within the time period for which the received power 920 exceeds the predetermined value.

If the peak exists after the preceding packet (No in step S2205), the collision detector 605 causes the process to proceed to step S2202 and determines that the packets do not collide with each other. If the peak does not exist after the preceding packet (Yes in step S2205), the collision detector 605 determines that the packets collide with each other (in step S2206) and terminates the process. In this case, the receiving device 130 uses the initial preamble to execute the channel estimation on the preceding packet, uses the last postamble to execute the channel estimation on the succeeding packet, and executes the signal separation based on the results of the channel estimation.

If the packet lengths are variable and the following conditions (1) to (3) are satisfied, the collision detector 605 determines that the packets collide with each other based on the length of the preceding packet that is indicated by the header included in the preceding packet.

(1) The power of the received signals continuously exceeds the predetermined value for a time period of the packet length of the preceding packet after the preamble of the preceding packet.

(2) A preamble exists near the start of the time period for which the power of the received signals continuously exceeds the predetermined value and a postamble exists near the end of the time period for which the power of the received signals continuously exceeds the predetermined value.

(3) A preamble does not exist after a preceding packet within the time period for which the power of the received signals continuously exceeds the predetermined value.

The orders that steps S2201 and S2203 to S2205 are executed may be switched with each other.

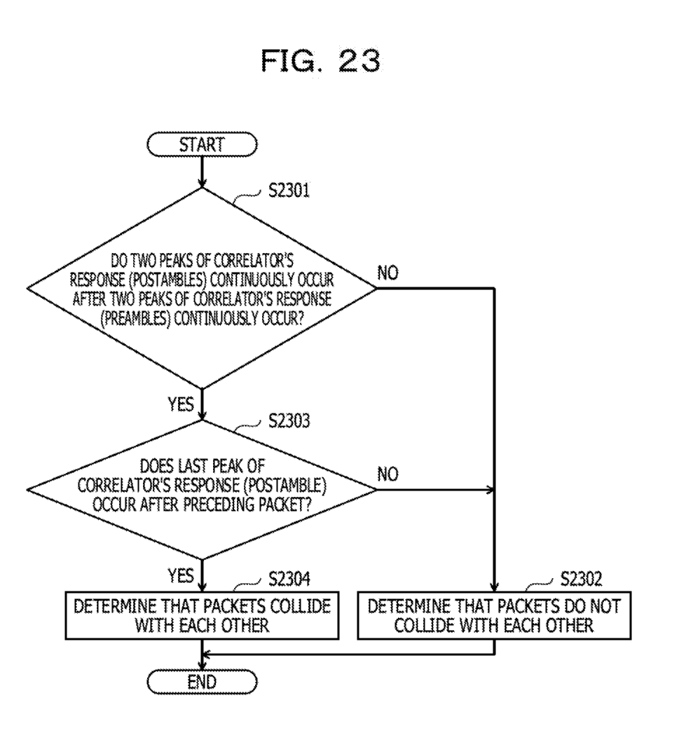

FIG. 23 is a flowchart of another example of the detection process to be executed by the collision detector according to the second embodiment in the case where the packet lengths are variable. In the case where the lengths of the packets transmitted by the transmitting devices 110 and 120 are variable, the collision detector 605 illustrated in FIG. 18 may execute steps illustrated in FIG. 23 in step S804 illustrated in FIG. 8, for example.

First, the collision detector 605 determines whether or not two peaks of the correlator's response 1910 that correspond to the postambles continuously occur after two peaks of the correlator's response 910 that correspond to the preambles continuously occur (in step S2301). The fact that the two peaks of the correlator's response 910 continuously occur is that, after a peak of the correlator's response 910 occurs, a peak of the correlator's response 910 occurs again before the occurrence of a peak of the correlator's response 1910. The fact that the two peaks of the correlator's response 1910 continuously occur is that, after a peak of the correlator's response 1910 occurs, a peak of the correlator's response 1910 occurs again before the occurrence of a peak of the correlator's response 910.

If the two peaks of the correlator's response 910 do not continuously occur or if the two peaks of the correlator's response 910 continuously occur and the two peaks of the correlator's response 1910 do not continuously occur after the occurrence of the two peaks of the correlator's response 910 (No in step S2301), the collision detector 605 causes the process to proceed to step S2302. Specifically, the collision detector 605 determines that the packets do not collide with each other (in step S2302) and terminates the detection process.

If the two peaks of the correlator's response 910 continuously occur and the two peaks of the correlator's response 1910 continuously occur after the occurrence of the two peaks of the correlator's response 910 (Yes in step S2301), the collision detector 605 causes the process to proceed to step S2303. Specifically, the collision detector 605 determines whether or not the last peak of the correlator's response 1910 occurs after the preceding packet (in step S2303). The last peak of the correlator's response 1910 is a peak that occurs within the time period for which the received power 920 (for example, the moving average of the instantaneous power) is high.

If the last peak of the correlator's response 1910 does not occur after the preceding packet (No in step S2303), the collision detector 605 causes the process to proceed to step S2302 and determines that the packets do not collide with each other. If the last peak of the correlator's response 1910 occurs after the preceding packet (Yes in step S2303), the collision detector 605 determines that the packets collide with each other (in step S2304) and terminates the detection process. In this case, the receiving device 130 uses the initial preamble to execute the channel estimation on the preceding packet, uses the last postamble to execute the channel estimation on the succeeding packet, and executes the signal separation based on the results of the channel estimation.

If the packet lengths are variable and the following conditions (1) and (2) are satisfied, the collision detector 605 may determine that the packets collide with each other based on the length of the preceding packet that is indicated by the header included in the preceding packet.

(1) The two postambles continuously exist after the two preambles continuously exist.

(2) The last postamble exists after a preceding packet within the time period for which the power of the received signals exceeds the predetermined value.

The orders that steps S2301 and S2303 are executed may be switched with each other.

(Other Example of Collision of Packets in Case where Packet Lengths are Variable in Second Embodiment)

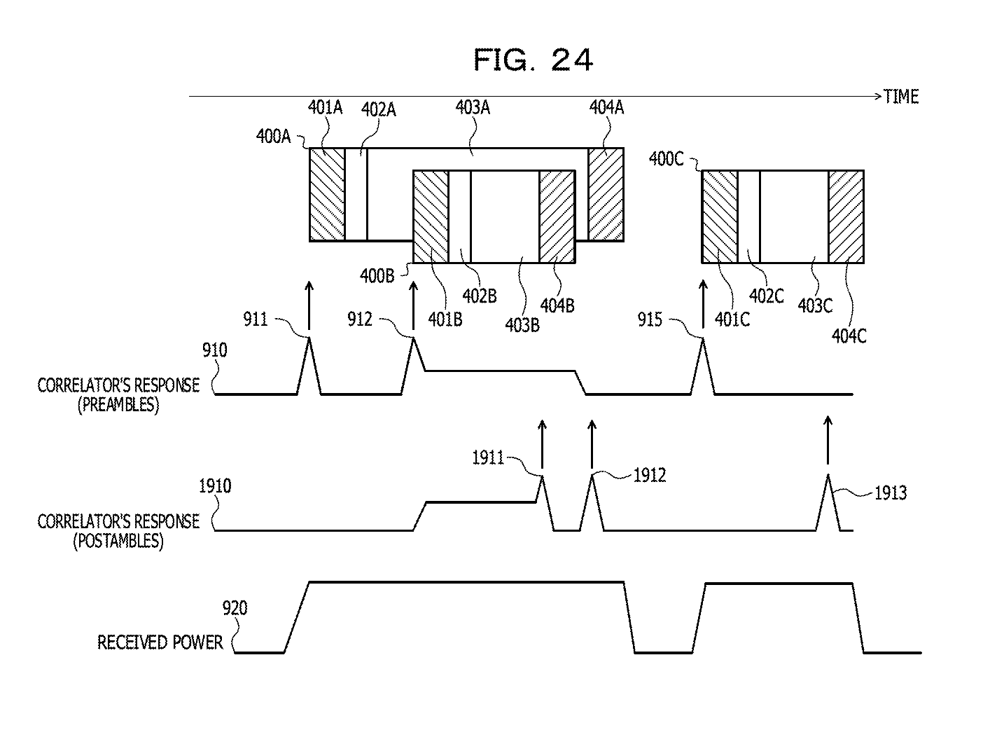

FIG. 24 illustrates another example of the collision of the packets in the case where the packet lengths are variable in the second embodiment. Parts that are illustrated in FIG. 24 and are the same as or similar to those illustrated in FIG. 15 or 21 are indicated by the same reference numbers and symbols as those illustrated in FIG. 15 or 21 and a description thereof is omitted. In the example illustrated in FIG. 24, a peak 915 that corresponds to the preamble 401C occurs in the correlator's response 910. In addition, a peak 1913 that corresponds to the postamble 404C occurs in the correlator's response 1910.

As illustrated in FIG. 24, if a time period of the length of the succeeding packet 400B is included in a time period of the length of the preceding packet 400A, it is difficult to execute the channel estimation on the packets 400A and 400B. In this case, the receiving device 130 outputs an error as the result of demodulating the packets, for example.

According to the second embodiment, even if the packets transmitted by the transmitting devices 110 and 120 collide with each other, the receiving device 130 may receive the colliding packets in the same manner as the first embodiment.

In addition, according to the second embodiment, the receiving device 130 may detect the collision of the packets transmitted by the transmitting devices 110 and 120 by using the known signals having the different patterns as the preambles and postambles.

(Network to which Communication System According to Embodiments is Applicable)

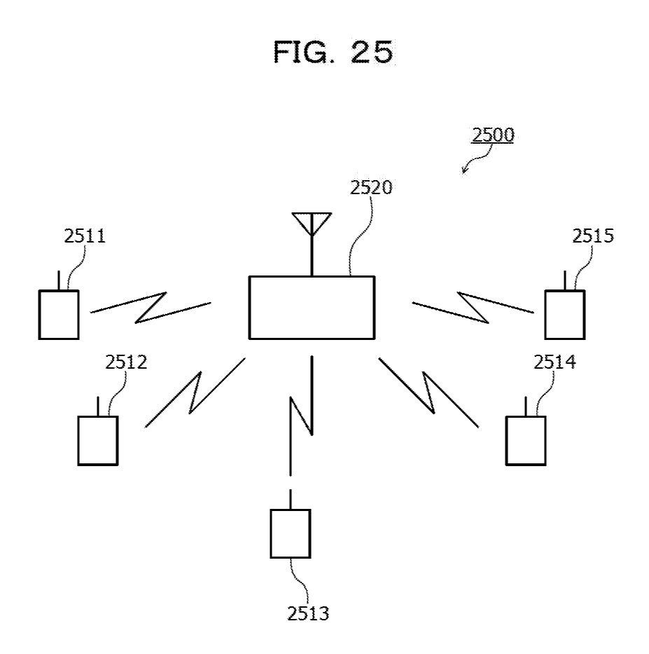

FIG. 25 illustrates an example of a network to which the communication system according to the embodiments is applicable. The communication system 100 according to the aforementioned embodiments is applied to a star network 2500 illustrated in FIG. 25, for example. The star network 2500 includes terminals 2511 to 2515 and a base station 2520. The terminals 2511 to 2515 wirelessly communicate with the base station 2520. In this case, packets transmitted by the terminals 2511 to 2515 may collide with each other in the base station 2520.

Each of the transmitting devices 110 and 120 illustrated in FIG. 1 is applied to any of the terminals 2511 to 2515, for example. The receiving device 130 illustrated in FIG. 1 is applied to the base station 2520, for example. Thus, even if the packets transmitted by the terminals 2511 to 2515 collide with each other, the base station 2520 may execute the signal separation and receive the packets.

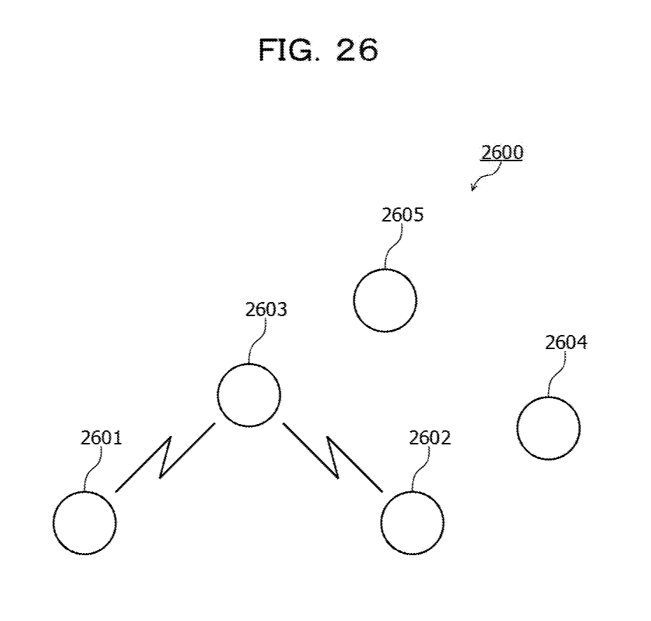

FIG. 26 illustrates another example of the network to which the communication system according to the embodiments is applicable. The communication system 100 according to the aforementioned embodiments may be applied to an ad-hoc network 2600 illustrated in FIG. 26, for example. The ad-hoc network 2600 includes terminals 2601 to 2605. The terminals 2601 to 2605 establish communication paths by wirelessly communicating with each other and transmit data.

Each of the transmitting devices 110 and 120 illustrated in FIG. 1 and the receiving device 130 illustrated in FIG. 1 is applied to any of the terminals 2601 to 2605, for example. As an example, the terminals 2601 and 2602 transmit packets and the packets transmitted by the terminals 2601 and 2602 collide with each other in the terminal 2603 in some cases. In such a case, the terminals 2601 and 2602 function as the transmitting devices 110 and 120 illustrated in FIG. 1 and the terminal 2603 functions as the receiving device 130 illustrated in FIG. 1. Thus, even if the packets transmitted by the terminals 2601 and 2602 collide with each other, the terminal 2603 may execute the signal separation and receive the packets.

As described above, according to the receiving device, the transmitting devices, and the communication method, if the packets collide with each other, the signal separation is executed on the packets, and the packets are received.

For example, traditionally, many sensor terminals are arranged in a wide range and sense various locations and things in a radio sensor network. Thus, from the perspective of a reduction in the cost of maintaining the sensor terminals and the like, it is desirable to drive the sensor terminals with low consumed power. In addition, if many sensor terminals are arranged and routing information or the like is installed in each of the sensor terminals, the arrangement cost may increase.

In order to reduce power to be consumed by sensor terminals, it is considered to use time division multiple access in which time is synchronized between the sensor terminals, communication times are assigned, and the sensor terminals become a sleep mode enabling reductions in power to be consumed in time periods other than the communication times, for example. In addition, in order to reduce the cost of arranging the sensor terminals, it is considered to use a star network in which sensor terminals are coupled to data collection parent stations and child stations while the ratio of the number of the data collection parent stations to the number of the child stations is 1:N or it is considered to use a radio ad-hoc network in which communication paths are automatically built between the terminals, for example.

In time division multiple access, however, communication that is not data transmission and is communication to be executed to synchronize time, communication to be executed to assign communication times, and the like is to be executed and power to be consumed is large. In addition, in the radio ad-hoc network, communication of control information for the building of paths is executed. In addition, in the 1:N star network in which time division multiple access is not used, it is considered that carrier sense is used to avoid the collision of signals, but a failure is known, which is caused by a hidden terminal problem that occurs in a case where terminals are arranged at positions at which the terminals are not able to communicate with each other.

In order to achieve a reduction in power to be consumed, it is considered that multiple antennas and receivers are arranged on a reception side without precontrol such as scheduling and colliding packets are separated using a signal separation technique known as SDM, MIMO, or the like, for example. SDM is an abbreviation for space division multiplexing. MIMO is an abbreviation for multiple input multiple output.

In order to execute the signal separation, however, channel information (channel estimation values) for the colliding packets is to be used but is not transmitted in advance in a network in which precontrol is not executed. In addition, in a method, to be executed in a WLAN, of inserting a known signal at the head of each packet, if packets collide with each other, only initial signals included in the colliding signals are appropriately received and it is difficult to execute the signal separation. The WLAN is an abbreviation of a wireless local area network.

On the other hand, according to the aforementioned embodiments, when packets are to be transmitted, known signals that are called preambles are inserted in heads of the packets, and known signals that are called postambles are inserted in tails of the packets. Then, the receiving device 130 detects the collision of the packets based on relationships between timings of detecting the preambles and the postambles and the packet lengths.

In addition, if the receiving device 130 detects the collision of the packets, the receiving device 130 calculates a channel estimation value for a preceding packet from the preamble of the preceding packet and calculates a channel estimation value for a succeeding packet from the postamble of the succeeding packet. Then, the receiving device 130 executes the signal separation on colliding portions of the colliding packets based on the calculated channel estimation values. Thus, the colliding packets are received.

For example, it is assumed that, in an environment in which 1000 terminals (nodes) exist in the same channel in the star network 2500 illustrated in FIG. 25, the terminals randomly transmit packets with lengths of 90 ms at transmission intervals of which the average is 10 minutes. In this case, a probability at which packets may collide with each other is 26% and the colliding packets are unlikely to be appropriately demodulated and to reach a destination in a conventional technique.

On the other hand, according to the aforementioned embodiments, if the lengths of the preambles and postambles are 10 ms and a payload collides, the signal separation may be executed in an ideal case. Thus, a probability at which the payload may collide and not be able to be demodulated may be reduced to approximately 7% and a probability at which the packets reach the destination may be improved.

In addition, on the receiving side, the channel estimation values to be used for the signal separation are obtained without large-scale calculation by a successive interference canceller (SIC) or the like. Thus, the signal separation is efficiently executed and an arrival rate of the packets is improved.

In addition, although the aforementioned embodiments describe the case where the packets transmitted by the transmitting devices 110 and 120 collide with each other, there may be a case where three or more packets transmitted by three or more transmitting devices collide with each other. In this case, the receiving device 130 outputs an error, for example. Alternatively, the aforementioned detection processes may be expanded and the receiving device 130 may detect the collision of the three or more packets.

In addition, the receiving device 130 may transmit response signals (ACKs or NACKs) to the packets transmitted by the transmitting devices 110 and 120, and the transmitting devices 110 and 120 may retransmit the packets based on the response signals transmitted by the receiving device 130. Thus, even if the receiving device 130 fails to detect the collision of the packets or fails to execute the signal separation, the retransmitted packets are received by the receiving device 130.

In addition, the transmitting devices 110 and 120 may execute the carrier sense (CS), confirm an available band, and transmit the packets. In this case, a packet may collide, for example, due to a hidden terminal or the like, but the signal separation is executed and the packets are received in the aforementioned embodiments.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A receiving device comprising:
a receiving circuit configured to receive a first packet and a second packet, each of the first packet and the second packet including a first signal in a head and a second signal in a tail, respectively; and
a processor coupled to the receiving circuit and configured to:
detect a collision of the first packet and the second packet based on a receiving timing of the first signal of the first packet, a receiving timing of the second signal of the first packet, and at least one of a receiving timing of the first signal of the second packet and a receiving timing of the second signal of the second packet,
after detecting the collision, separate the first packet and the second packet based on the first signal of the first packet and the second signal of the second packet, and
demodulate the separated first packet and the separated second packet, respectively.

2. The receiving device according to claim 1, wherein
in detecting the receiving timing of the second signal of the first packet, the processor is configured to specify the receiving timing of the second signal of the first packet based on a first time length of the first packet and the receiving timing of the first signal of the first packet.

3. The receiving device according to claim 2, the processor is further configured to:
determine a first channel estimation value based on the first signal of the first packet and a second channel estimation value based on the second signal of the second packet, wherein
the demodulating of the first packet is executed based on the first channel estimation value, and the demodulating of the second packet is executed based on the second channel estimation value.

4. The receiving device according to claim 2, wherein
the first signals of the first packet and the second packet have a first pattern and the second signals of the first packet and the second packet have the first pattern,
the first time length of the first packet is the same as a second time length of the second packet, and
the processor is configured to detect the collision of the first packet and the second packet when at least four signals having the first pattern are detected within a time period that is twice of the first length.

5. The receiving device according to claim 2, wherein
the first signals of the first packet and the second packet have a first pattern and the second signals of the first packet and the second packet have the first pattern,
the first time length is indicated in a header included in the first packet, and
the processor is configured to detect the collision of the first packet and the second packet when power of the signals received by the receiving circuit continuously exceeds a certain value for a time period longer than the first time length of the first packet and at least three signals having the first pattern are detected within the first time period.

6. The receiving device according to claim 2, wherein
the first signals of the first packet and the second packet have a first pattern and the second signals of the first packet and the second packet have the first pattern,
the first time length is indicated in a header included in the first packet, and
the processor is configured to detect the collision of the first packet and the second packet when power of the signals received by the receiving circuit continuously exceeds a certain value for a time period longer than the first time length of the first packet and at least two signals having the first pattern are detected near an end of the time period for which the power of the signals received by the receiving circuit continuously exceeds the certain value.

7. The receiving device according to claim 2, wherein
the first signals of the first packet and the second packet have a first pattern and the second signals of the first packet and the second packet have a second pattern different from the first pattern,
the first time length of the first packet is the same as a second time length of the second packet, and
the processor is configured to detect the collision of the first packet and the second packet when the second packet is detected at least twice within the first time length.

8. The receiving device according to claim 2, wherein
the first signals of the first packet and the second packet have a first pattern and the second signals of the first packet and the second packet have a second pattern different from the first pattern,
the first time length is indicated in a header included in the first packet, and
the processor is configured to detect the collision of the first packet and the second packet when power of the signals received by the receiving circuit continuously exceeds a certain value for a time period longer than the first time length of the first packet and not detect the first pattern within the time period and after the first time length from a head of the time period.

9. The receiving device according to claim 2, wherein
the first signals of the first packet and the second packet have a first pattern and the second signals of the first packet and the second packet have a second pattern different from the first pattern,
the first time length is indicated in a header included in the first packet, and
the processor is configured to detect the collision of the first packet and the second packet when the processor detects the second pattern twice successively after detecting the first pattern twice successively.

10. The receiving device according to claim 1, further comprising:
a plurality of antennas coupled to the receiving circuit and configured to receive the first packet and the second packet and send the received first packet and the received second packet to the receiving circuit.

11. A method of demodulating a packet received by a receiving device, comprising:
receiving, by the receiving device, a first packet and a second packet, each of the first packet and the second packet including a first signal in a head and a second signal in a tail, respectively;
detecting, by the receiving device, a collision of the first packet and the second packet based on a receiving timing of the first signal of the first packet, a receiving timing of the second signal of the first packet, and at least one of a receiving timing of the first signal of the second packet and a receiving timing of the second signal of the second packet;
after detecting the collision, separating, by the receiving device, the first packet and the second packet based on the first signal of the first packet and the second signal of the second packet; and
demodulating, by the receiving device, the separated first packet and the separated second packet, respectively.

12. The method according to claim 11, wherein in detecting the receiving timing of the second signal of the first packet, specifying the receiving timing of the second signal of the first packet based on a first time length of the first packet and the receiving timing of the first signal of the first packet.

13. The method according to claim 12, further comprising:
determining a first channel estimation value based on the first signal of the first packet and a second channel estimation value based on the second signal of the second packet, wherein
the demodulating of the first packet is executed based on the first channel estimation value, and the demodulating of the second packet is executed based on the second channel estimation value.

14. The method according to claim 12, wherein
the first signals of the first packet and the second packet have a first pattern and the second signals of the first packet and the second packet have the first pattern,
the first time length of the first packet is the same as a second time length of the second packet, and
in the detecting the collision, determining whether at least four signals having the first pattern are detected within a time period that is twice of the first length.

15. The method according to claim 12, wherein
the first signals of the first packet and the second packet have a first pattern and the second signals of the first packet and the second packet have the first pattern,
the first time length is indicated in a header included in the first packet, and
in the detecting the collision, determining whether power of the signals received by the receiving circuit continuously exceeds a certain value for a time period longer than the first time length of the first packet and at least three signals having the first pattern are detected within the first time period.

16. The method according to claim 12, wherein
the first signals of the first packet and the second packet have a first pattern and the second signals of the first packet and the second packet have the first pattern,
the first time length is indicated in a header included in the first packet, and
in the detecting the collision, determining whether power of the signals received by the receiving circuit continuously exceeds a certain value for a time period longer than the first time length of the first packet and at least two signals having the first pattern are detected near an end of the time period for which the power of the signals received by the receiving circuit continuously exceeds the certain value.

17. The method according to claim 12, wherein
the first signals of the first packet and the second packet have a first pattern and the second signals of the first packet and the second packet have a second pattern different from the first pattern,
the first time length of the first packet is the same as a second time length of the second packet, and
in the detecting the collision, determining whether the second packet is detected at least twice within the first time length.

18. The method according to claim 12, wherein
the first signals of the first packet and the second packet have a first pattern and the second signals of the first packet and the second packet have a second pattern different from the first pattern,
the first time length is indicated in a header included in the first packet, and
in the detecting the collision, determining whether power of the signals received by the receiving circuit continuously exceeds a certain value for a time period longer than the first time length of the first packet and not detect the first pattern within the time period and after the first time length from a head of the time period.

19. The method according to claim 12, wherein
the first signals of the first packet and the second packet have a first pattern and the second signals of the first packet and the second packet have a second pattern different from the first pattern,
the first time length is indicated in a header included in the first packet, and
in the detecting the collision, determining whether the processor detects the second pattern twice successively after detecting the first pattern twice successively.

20. The method according to claim 11, wherein the receiving device includes a receiving circuit and a plurality of antennas coupled to the receiving circuit and configured to receive the first packet and the second packet and send the received first packet and the received second packet to the receiving circuit.
